(19) United States
(12) Patent Application Publication
(10) Pub. No.: US 2025/0280081 A1
(43) Pub. Date: Sep. 4, 2025

(54) DOCUMENT PROCESSING APPARATUS AND DOCUMENT PROCESSING SYSTEM

(71) Applicant: Jun YAMADA, Kanagawa (JP)

(72) Inventor: Jun YAMADA, Kanagawa (JP)

(73) Assignee: Ricoh Company, Ltd., Tokyo (JP)

(21) Appl. No.: 19/053,927

(22) Filed: Feb. 14, 2025

(30) Foreign Application Priority Data
Feb. 29, 2024 (JP) 2024-030067

(51) Int. Cl. H04N 1/00

(52) U.S. Cl. CPC H04N 1/00652; H04N 1/00694; H04N 1/00716

(57) ABSTRACT

A document processing apparatus includes a document tray, a document conveyor, and circuitry. The document tray is a tray on which a document is placed. The document conveyor conveys the document from the document tray. The circuitry is to acquire information of the document, determine a conveyance amount to convey the document, based on a first classification of the document previously set, estimate a second classification of the document based on the information of the document acquired, and change the conveyance amount when the first classification is different from the second classification.

### CROSS-REFERENCE TO RELATED APPLICATION

This patent application is based on and claims priority pursuant to 35 U.S.C. § 119(a) to Japanese Patent Application No. 2024-030067, filed on Feb. 29, 2024, in the Japan Patent Office, the entire disclosure of which is hereby incorporated by reference herein.

### BACKGROUND

### Technical Field

Embodiments of the present disclosure relate to a document processing apparatus and a document processing system.

### Background Art

Typical automatic document feeders (ADF) to be attached to a multifunction peripheral (MFP) are known that read original documents with a technique in which the sheet thickness of an original document is set to perform conveyance control of the original document according to the sheet thickness setting.

An ADF in the art uses a trained model obtained through machine learning to specify the kind of an original document from a read image of the original document, so as to determine the image forming condition.

Typical sheet thickness settings require the setting by the user before the image reading starts. If the user does not know how to set the sheet thickness, if the user forgets the sheet thickness setting, or if the thickness of the original document placed on the document tray does not match the sheet thickness setting, optimum conveyance control of an original document for each sheet thickness setting cannot be executed. The above-described ADF in the art does not solve the problem that such an optimum conveyance control of an original document for each sheet thickness setting cannot be executed.

### SUMMARY

Embodiments of the present disclosure described herein provide a novel document processing apparatus including a document tray, a document conveyor, and circuitry. The document tray is a tray on which a document is placed. The document conveyor conveys the document from the document tray. The circuitry is to acquire information of the document, determine a conveyance amount to convey the document, based on a first classification of the document previously set, estimate a second classification of the document based on the information of the document acquired, and change the conveyance amount when the first classification is different from the second classification.

Further, embodiments of the present disclosure described herein provide a document processing system including a document processing apparatus and an external device. The document processing apparatus includes a document tray, a document conveyor, and circuitry. The document tray is a tray on which a document is placed. The document conveyor conveys the document from the document tray. The circuitry is to acquire information of the document, and determine a conveyance amount to convey the document, based on a first classification of the document determined in advance. The external device includes circuitry configured to estimate a second classification of the document based on the information of the document as an input. The circuitry of the document processing apparatus is further to change the conveyance amount when the first classification of the document determined in advance and a result of the second classification of the document are different from each other.

Further, embodiments of the present disclosure described herein provide a document processing apparatus including a document tray, a document conveyor, and circuitry. The document tray is a tray on which a document is placed. The document conveyor conveys the document from the document tray. The circuitry is to acquire a size of the document, determine a conveyance amount to convey the document, based on a first thickness of the document previously set, estimate a second thickness of the document based on the size of the document acquired, and change the conveyance amount when the first thickness is different from the second thickness.

### BRIEF DESCRIPTION OF THE SEVERAL VIEWS OF THE DRAWINGS

Exemplary embodiments of this disclosure will be described in detail based on the following figures, wherein:

FIG. 1 is a schematic diagram illustrating an example of a copier according to an embodiment of the present disclosure;

FIG. 2 is a diagram illustrating a part of an internal configuration of an image forming device included in the copier of FIG. 1;

FIG. 3 is a partially enlarged view of a part of a tandem unit including four image forming unit of the image forming device of FIG. 2;

FIG. 4 is a perspective view of a scanner and an automatic document feeder of the copier of FIG. 1;

FIG. 5 is an enlarged view of a main part of the automatic document feeder and the upper part of the scanner of FIG. 4;

FIG. 6 is a block diagram illustrating a part of an electric circuit in a copier according to an embodiment of the present disclosure;

FIG. 7 is a flowchart of an example of a document thickness setting change and a reading operation when a sheet thickness is estimated from size information;

FIG. 8 is a diagram illustrating an example of a document thickness resetting notification screen;

FIG. 9 is a diagram illustrating an example of a generation step of a trained model by machine learning;

FIG. 10 is a diagram illustrating an example of a training data analyzed by machine learning;

FIG. 11 is a diagram illustrating an inference step using a trained model by machine learning;

FIG. 12 is a flowchart of an example of specific steps to completion of a trained model by deep learning (DL) using neural network (NN);

FIGS. 13A and 13B are diagrams each illustrating an example of thresholds of matching degrees and estimation results;

FIG. 14 is a diagram illustrating an example of a document thickness determination level setting screen;

FIGS. 15A and 15B are the first and second parts of a flowchart of a screen transition according to an embodiment of the present disclosure;

FIG. 16 is a diagram illustrating an example of a document thickness setting screen;

FIG. 17 is a diagram illustrating an example of a document thickness detection auto setting screen;

FIGS. 18A and 18B are the first and second parts of a flowchart of a process flow of a document thickness setting change and a reading operation using a trained model; and

FIG. 19 is a diagram illustrating an example of optimum conveyance parameters for each sheet thickness.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. Identical reference numerals are assigned to identical or equivalent components and a description of those components may be simplified or omitted.

Descriptions are given below of a basic structure of an image forming apparatus, such as a copier using an electrophotography (simply referred to as a “copier”), to which one or more of aspects of the present disclosure is applied.

A description is now given of the basic configuration of a copier as an image forming apparatus according to the present embodiment.

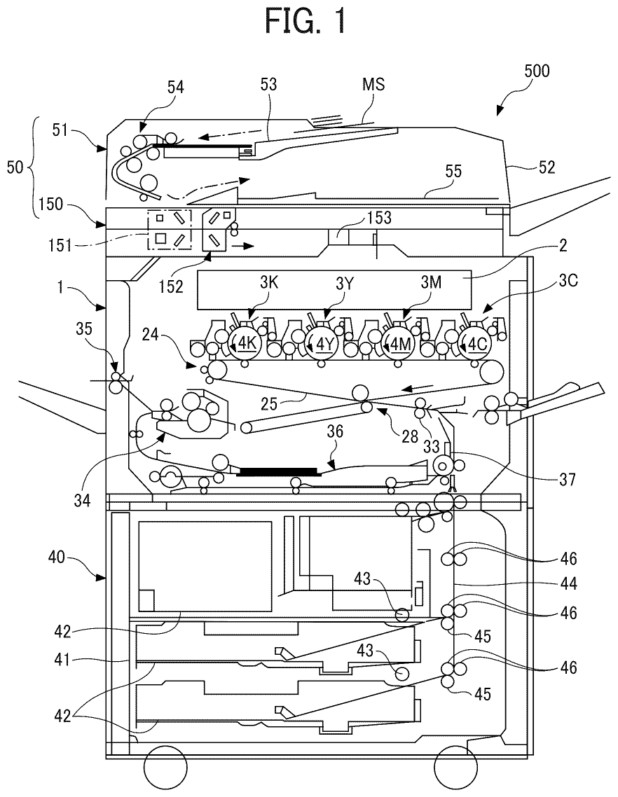

FIG. 1 is a schematic diagram illustrating an example of a copier 500 according to an embodiment of the present disclosure.

As illustrated in FIG. 1, the copier 500 includes an image forming device 1 as an image forming apparatus, a sheet feeding device 40, and an image reading system 50. The image reading system 50 includes a scanner 150 as an image reading device that is fixed on the image forming device 1, and an automatic document feeder (ADF) 51 supported by the scanner 150.

The sheet feeding device 40 includes a sheet bank 41, two sheet trays 42 disposed one above the other in the sheet bank 41, sheet feed rollers 43 each of which picking up a recording sheet from a selected one of the two sheet trays 42, and sheet separation rollers 45 each of which separating multiple recording sheets fed by the sheet feed rollers 43. The sheet feeding device 40 further includes multiple sheet conveyance roller pairs 46 each of which conveying the recording sheet in a sheet conveyance path 37 as a conveyance path in the image forming device 1.

Each of the two sheet trays 42 accommodates multiple recording sheets overlapping each other in a form of a sheet bundle. The sheet feed roller 43 press-contacts the uppermost sheet of the multiple recording sheets in each of the two sheet trays 42. As the sheet feed roller 43 rotates, the uppermost recording sheet of the sheet bundle is fed from the selected one of the sheet trays 42.

The multiple sheet conveyance roller pairs 46 are disposed near the multiple sheet trays 42. Each of the multiple sheet conveyance roller pairs 46 includes a first conveyance roller and a second conveyance roller adjacent to (on the right side of FIG. 1) the first conveyance roller. The first conveyance roller and the second conveyance roller of each of the multiple sheet conveyance roller pairs 46 are in contact with each other to form a conveyance nip region.

A sheet separation roller 45 is disposed below the first conveyance roller of each of the multiple sheet conveyance roller pairs 46 and is in contact with the first conveyance roller from below to form a separation conveyance nip region.

A recording sheet fed from one of the sheet trays 42 driven and rotated by a corresponding one of the sheet feed rollers 43 enters the separation conveyance nip region formed by the contact of the first conveyance roller of a sheet conveyance roller pair 46 and a sheet separation roller 45 disposed below the first conveyance roller. In the separation conveyance nip region, the first conveyance roller that contacts the upper face of the recording sheet applies a conveyance force to the recording sheet from the sheet tray 42 toward a sheet feeding path 44 as the first conveyance roller is driven and rotated in the counterclockwise direction in FIG. 1. In contrast, the sheet separation roller 45 that is in contact with the lower face of the recording sheet applies a conveyance force to the recording sheet from the sheet feeding path 44 toward the sheet tray 42 as the sheet separation roller 45 is driven and rotated in the counterclockwise direction in FIG. 1, thereby returning the recording sheet to the sheet tray 42.

When only one recording sheet is fed from the sheet tray 42, the first conveyance roller of the sheet conveyance roller pair 46 and the sheet separation roller 45 apply the conveyance force to the recording sheet toward opposite directions to each other in the separation conveyance nip region. As a result, a load exceeding a given threshold value is applied to the drive transmission part of the sheet separation roller 45. Then, a torque limiter disposed in the drive transmission part of the sheet separation roller 45 is operated to cut off the transmission of the driving force from a direct current (DC) brushless motor to the sheet separation roller 45.

Accordingly, the sheet separation roller 45 is rotated with the recording sheet that is conveyed by the first conveyance roller, and the recording sheet is then ejected from the separation conveyance nip region to the sheet feeding path 44.

On the other hand, when the multiple recording sheets are fed from the sheet tray 42 with the multiple recording sheets overlapped to each other, the first conveyance roller applies the conveyance force to the uppermost recording sheet of the multiple recording sheets from the sheet tray 42 toward the sheet feeding path 44 in the separation conveyance nip region. The uppermost recording sheet of the multiple recording sheets is fed from the separation conveyance nip region toward the sheet feeding path 44. On the other hand, the sheet separation roller 45 applies the conveyance force from the sheet feeding path 44 toward the sheet tray 42 to the lower recording sheet or sheets of the multiple recording sheets, so that the lower recording sheet is (or sheets are) reversed from the separation conveyance nip region toward the sheet tray 42. Accordingly, in the separation conveyance nip region, the uppermost recording sheet is separated from other recording sheet or sheets so as to be conveyed alone to the sheet feeding path 44.

The recording sheet on the sheet feeding path 44 enters the conveyance nip region of the sheet conveyance roller pair 46 where the conveyance force is applied upward from below in the vertical direction. Accordingly, the recording sheet in the sheet feeding path 44 is conveyed toward the sheet conveyance path 37 of the image forming device 1.

The image forming device 1 includes an optical writing device 2, and four image forming units 3K, 3Y, 3M and 3C. The image forming units 3K, 3Y, 3M and 3C form black, yellow, magenta, and cyan toner images, respectively. The image forming device 1 further includes a transfer unit 24, a sheet conveyance unit 28, a registration roller pair 33, a fixing device 34, a switchback device 36, and the sheet conveyance path 37. The optical writing device 2 includes a light source such as a laser diode and a light emitting diode (LED). The light source is disposed in the optical writing device 2. The optical writing device 2 drives the light source to emit laser lights L toward four drum-shaped photoconductors 4K, 4Y, 4M and 4C to irradiate respective surfaces of the drum-shaped photoconductors 4K, 4Y, 4M and 4C. This emission of the laser lights L results in formation of an electrostatic latent image on each surface of the photoconductors 4K, 4Y, 4M and 4C. This electrostatic latent image is developed into a visible toner image through a given development process.

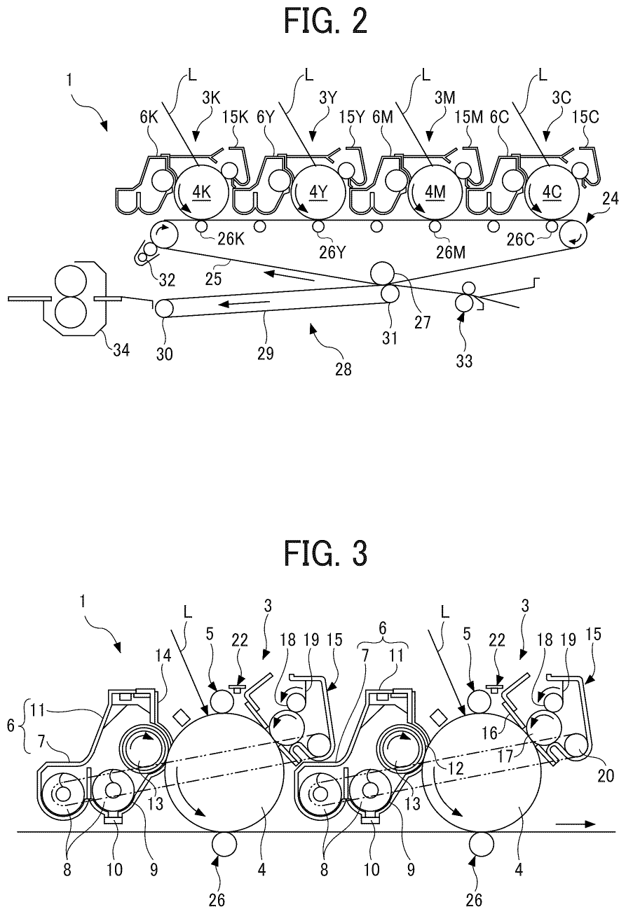

FIG. 2 is a diagram illustrating a part of the internal configuration of the image forming device 1 included in the copier 500 of FIG. 1.

FIG. 3 is a partially enlarged view of a part of a tandem unit including four image forming units 3K, 3Y, 3M and 3C of the image forming device 1 of FIG. 2.

Since the four image forming units 3K, 3Y, 3M and 3C have respective configurations substantially the same as each other except the toner colors, the image forming units 3K, 3Y, 3M, and 3C are also described without suffixes indicating the toner colors, which are K, Y, M and C in FIG. 3. For example, the image forming units 3K, 3Y, 3M and 3C may be also referred to as a “image forming unit 3” in a single form.

Each of the image forming units 3K, 3Y, 3M and 3C also includes respective image forming components disposed around the corresponding one of the photoconductors 4K, 4Y, 4M and 4C, as a single unit, supported by a common support member. The image forming units 3K, 3Y, 3M and 3C are detachably attached to the image forming device 1. The image forming unit 3 (i.e., the image forming units 3K, 3Y, 3M and 3C) includes the photoconductor 4 (i.e., the photoconductors 4K, 4Y, 4M and 4C), and a charging device 5, a developing device 6 (i.e., developing devices 6K, 6Y, 6M, and 6C), a drum cleaning device 15 (i.e., drum cleaning devices 15K, 15Y, 15M, and 15C), and an electric discharging lamp 22 around the photoconductor 4. The copier 500 is a tandem image forming system in which the four image forming units 3K, 3Y, 3M and 3C are aligned in a direction of movement of an intermediate transfer belt 25 as an endless loop, which is described below.

The photoconductor 4 (i.e., the photoconductors 4K, 4Y, 4M and 4C) is manufactured by a hollow tube made of aluminum, for example, with a drum shape covered by an organic photoconductive layer having photosensitivity. The photoconductor 4 may have a shape of endless belt.

The developing device 6 (i.e., the developing devices 6K, 6Y, 6M, and 6C) develops an electrostatic latent image into a visible toner image by a two-component developer including magnetic carrier particles and non-magnetic toner. The two-component developer is now referred to as a “developer”. The developing device 6 includes an agitating portion 7 and a development portion 11. The agitating portion 7 stirs the two-component developer accommodated therein and conveys the two-component developer to a development sleeve 12. The development portion 11 supplies the non-magnetic toner, which is included in the two-component developer and held by the development sleeve 12, to the photoconductor 4 (i.e., the photoconductors 4K, 4Y, 4M and 4C).

The agitating portion 7 is located at a position lower than the development portion 11 and includes two screw, a partition, a development case 9, and a toner concentration sensor 10. The two transfer screws 8 are disposed in parallel to each other. The partition is disposed between the two transfer screws 8. The development case 9 has an opening or a slot to face the photoconductor 4. The toner concentration sensor 10 is disposed on the bottom of the development case 9.

The development portion 11 includes the development sleeve 12, a magnetic roller 13, and a doctor blade 14. The development sleeve 12 faces the photoconductor 4 (i.e., the photoconductors 4K, 4Y, 4M and 4C) through the opening (or the slot) of the development case 9. The magnetic roller 13 is fixedly or unrotatably disposed inside the development sleeve 12. The doctor blade 14 is disposed adjacent to the development sleeve 12 and the leading end of the doctor blade 14 is disposed close to the development sleeve 12. The development sleeve 12 has a non-magnetic, rotatable tubular body.

The magnetic roller 13 has multiple magnetic poles arranged in the order in a rotation direction of the development sleeve 12, starting from an opposed position to the doctor blade 14. Each of these magnetic poles applies a magnetic force at a predetermined position in the rotation direction of the development sleeve 12, with respect to the two-component developer supplied on the development sleeve 12. With this action of the magnetic roller 13, the two-component developer that is conveyed from the agitating portion 7 is attracted and attached to the surface of the development sleeve 12 and a magnetic brush of toner is formed along the lines of the magnetic force on the surface of the development sleeve 12.

In accordance with rotation of the development sleeve 12, the magnetic brush is regulated to have an appropriate layer thickness when passing by the opposed position to the doctor blade 14. Then, the magnetic brush is moved to a development region facing the photoconductor 4 (i.e., the photoconductors 4K, 4Y, 4M and 4C). Due to a difference of potentials between a development bias that is applied to the development sleeve 12 and an electrostatic latent image formed on the surface of the photoconductor 4 (i.e., the photoconductors 4K, 4Y, 4M and 4C), the toner is transferred onto the electrostatic latent image, so that the electrostatic latent image is developed into a visible toner image.

Further, after returning into the development portion 11 again along with the rotation of the development sleeve 12 then leaving from the surface of the development sleeve 12 due to repulsion of the magnetic field formed between the magnetic poles of the magnetic roller 13, the two-component developer in a form of the magnetic brush is returned to the agitating portion 7. An appropriate amount of toner is supplied to the two-component developer in the agitating portion 7 based on a result or results detected by the toner concentration sensor 10. Alternative to the two-component developer, the developing device 6 according to the present embodiment may employ one-component developer that does not include magnetic carriers.

The drum cleaning device 15 (i.e., the drum cleaning devices 15K, 15Y, 15M, and 15C) includes a cleaning blade 16, a fur brush 17, an electric field roller 18, a scraper 19, and a collection screw 20. The cleaning blade 16 is an elastic member to be pressed against the photoconductor 4, so as to scrape residual toner remaining on the surface of the photoconductor 4. In the present embodiment, the drum cleaning device 15 employs a blade member such as the cleaning blade 16, however, the configuration is not limited thereto. Alternative to the blade member, a brush roller, for example, can be applied to the drum cleaning device 15. The fur brush 17 according to the present embodiment is provided in order to increase the cleanability. The fur brush 17 is a conductive member and the outer circumferential face of the fur brush 17 slidably contacts the photoconductor 4 (i.e., the photoconductors 4K, 4Y, 4M and 4C). The fur brush 17 according to the present embodiment is rotatable in a direction indicated by arrow in FIG. 3.

The fur brush 17 also functions as an applier that scrapes a solid lubricant to obtain fine powder of lubricant and applies the scraped fine powder to the surface of the photoconductor 4 (i.e., the photoconductors 4K, 4Y, 4M and 4C). The electric field roller 18 is a metallic member that applies a bias to the fur brush 17. The electric field roller 18 is disposed rotatably in a direction indicated by arrow in FIG. 3. The scraper 19 has a leading end that is pressed against the electric field roller 18. The toner removed from the photoconductor 4 and attached to the fur brush 17 is transferred onto the electric field roller 18 that contacts the fur brush 17 in a counter direction to be applied with a bias while the electric field roller 18 is rotating. After being scraped and removed from the electric field roller 18 by the scraper 19, the toner collected by the scraper 19 falls onto the collection screw 20. The collection screw 20 conveys the toner collected from the surface of the photoconductor 4 toward an end portion of the drum cleaning device 15 in a direction orthogonal to the drawing sheet, and transfers the collected toner to an external toner recycling transfer device. The external toner recycling transfer device sends the collected toner to the developing device 6 (i.e., the developing devices 6K, 6Y, 6M, and 6C) for recycling.

The electric discharging lamp 22 removes residual electric charge remaining on the surface of the photoconductor 4 (i.e., the photoconductors 4K, 4Y, 4M and 4C) by photo irradiation. After such residual electric charge is removed, the electrically discharged surface of the photoconductor 4 (i.e., the photoconductors 4K, 4Y, 4M and 4C) is uniformly charged by the charging device 5 again and then optically irradiated by the optical writing unit 2. In the image forming device 1 according to the present embodiment, the charging device 5 illustrated in FIG. 3 is a charging roller that is applied with charging bias and rotates while contacting the photoconductor 4 (i.e., the photoconductors 4K, 4Y, 4M and 4C). However, in some embodiments, the charging device 5 may be a scorotron charger that performs a charging process on the photoconductor 4 (i.e., the photoconductors 4K, 4Y, 4M and 4C) in non-contact with the photoconductor 4.

According to the above-described operations with the configuration illustrated in FIG. 2, black (K), yellow (Y), magenta (M), and cyan (C) toner images are formed on the photoconductors 4K, 4Y, 4M and 4C of the image forming units 3K, 3Y, 3M and 3C, respectively. The transfer unit 24 is disposed below the image forming units 3K, 3Y, 3M and 3C. The transfer unit 24 endlessly moves the intermediate transfer belt 25 in the clockwise direction in FIG. 2 while the intermediate transfer belt 25 is stretched by and would around multiple rollers and is in contact with the photoconductors 4K, 4Y, 4M and 4C. By so doing, respective primary transfer nip regions for forming black, yellow, magenta, and cyan images are formed between the photoconductors 4K, 4Y, 4M and 4C and the intermediate transfer belt 25 of an endless loop in contact with each other.

In proximity to each of the primary transfer nip regions for black, yellow, magenta, and cyan images, the primary transfer rollers 26 (i.e., the primary transfer rollers 26K, 26Y, 26M and 26C) are disposed in contact with the inner loop of the intermediate transfer belt 25 to press the intermediate transfer belt 25 against the photoconductors 4 (i.e., the photoconductors 4K, 4Y, 4M and 4C), respectively. A primary transfer bias is applied by respective transfer bias power supplies to the primary transfer rollers 26K, 26Y, 26M and 26C. Consequently, respective primary transfer electric fields are generated in the primary transfer nip regions to electrostatically transfer respective toner images formed on the photoconductors 4K, 4Y, 4M and 4C onto the intermediate transfer belt 25.

As the intermediate transfer belt 25 passes through the primary transfer nip regions along the endless rotation in the clockwise direction in FIG. 2, the black, yellow, magenta, and cyan toner images are sequentially transferred at the primary transfer nip regions and overlaid onto an outer circumferential face of the intermediate transfer belt 25. Due to the primary transfer of the toner images, a four-color composite toner image (referred to as a four-color toner image) is formed on the surface of the intermediate transfer belt 25.

The sheet conveyance unit 28 is disposed below the transfer unit 24 in FIG. 2. The sheet conveyance unit 28 includes a sheet transfer belt 29, a sheet transfer belt drive roller 30, and a secondary transfer roller 31. The sheet transfer belt 29 is an endless belt that is wound around the sheet transfer belt drive roller 30 and the secondary transfer roller 31 and rotates in a direction indicated by arrow in FIG. 2. As illustrated in FIG. 2, the intermediate transfer belt 25 and the sheet transfer belt 29 are sandwiched between the secondary transfer roller 31 and a lower tension roller 27 of the transfer unit 24. According to this configuration, a secondary transfer nip region is formed between the surface of the intermediate transfer belt 25 and the surface of the sheet transfer belt 29 contacting with each other. A secondary transfer bias is applied by a transfer bias power source to the secondary transfer roller 31. On the other hand, the lower tension roller 27 of the transfer unit 24 is electrically grounded. By so doing, a secondary transfer electric field is formed in the secondary transfer nip region.

The registration roller pair 33 is disposed on a right side of the secondary transfer nip region in FIGS. 2 and 3. A registration roller sensor is disposed adjacent to an entrance of the registration nip region of the registration roller pair 33. The recording sheet is conveyed from the sheet feeding device 40 to the registration roller pair 33. After a given time has elapsed from the detection of the leading end of the recording sheet by the registration roller sensor, the conveyance of the recording sheet temporarily stops, and the leading end of the recording sheet contacts the registration nip region of the registration roller pair 33.

After the leading end of the recording sheet contacts the registration nip region of the registration roller pair 33, the registration roller pair 33 restarts the rotation to synchronize the movement of the recording sheet with the movement of the four-color toner image formed on the intermediate transfer belt 25. Consequently, the recording sheet nipped between the registration roller pair 33 is conveyed to the secondary transfer nip region. When the four-color toner image formed on the intermediate transfer belt 25 closely contacts the recording sheet at the secondary transfer nip region, the four-color toner image on the intermediate transfer belt 25 is transferred onto the recording sheet in the secondary transfer due to the secondary transfer electric field or the nip pressure. At this time, the four-color toner image is combined with white color of the recording medium to make a full-color image. After passing through the secondary transfer nip region, the recording sheet having the full-color toner image on the surface is separated from the intermediate transfer belt 25. Then, while being held on the front face of the sheet transfer belt 29, the recording sheet is conveyed to the fixing device 34 along with endless rotation of the sheet transfer belt 29 in the direction as illustrated in FIG. 3.

Residual toner that has not been transferred onto the recording sheet in the secondary transfer nip region remains on the surface of the intermediate transfer belt 25 after the intermediate transfer belt 25 has passed through the secondary transfer nip region. The residual toner is scraped and removed from the surface of the intermediate transfer belt 25 by a belt cleaning device 32 that is disposed in contact with the surface of the intermediate transfer belt 25.

The recording sheet is conveyed to the fixing device 34. The fixing device 34 fixes the full-color toner image to the recording sheet by application of heat and pressure. Then, the recording sheet is conveyed from the fixing device 34 to the sheet ejection roller pair 35 to be ejected to the outside of the image forming device 1.

As illustrated in FIG. 1, the switchback device 36 is disposed below the sheet conveyance unit 28 and the fixing device 34. As a result of the above-described operation, after the image fixing operation is performed on one side or the surface of the recording sheet, a switching member switches the direction of conveyance of the recording sheet. Specifically, the direction of conveyance of the recording sheet is switched to a passage to the switchback device 36 by the switching member. When the recording sheet is conveyed to the transfer reversal device, the recording sheet is reversed to enter the secondary transfer nip region of the copier 500 again. In the image forming device 1, a toner image is secondarily transferred onto the other side or a back face of the recording sheet so that the secondary transfer process and the fixing process are executed. Then, the recording sheet is ejected onto the ejection tray.

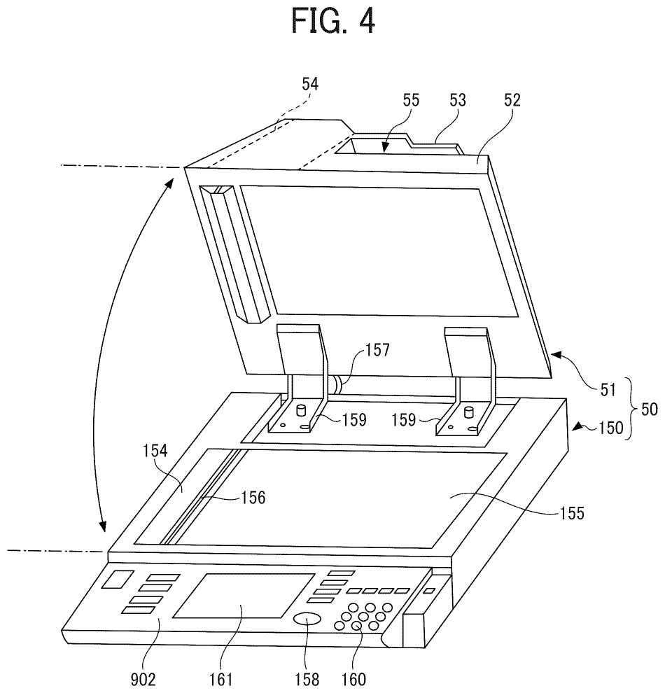

The scanner 150 fixed to the image forming device 1 includes a movable reading unit 152. The scanner 150 and the automatic document feeder 51 (simply referred to as an ADF 51) include fixed reading units. The movable reading unit 152 is disposed immediately below a second exposure glass 154 (see FIG. 4) that is fixedly mounted on the upper wall of a casing of the scanner 150 so as to contact an original document MS. The movable reading unit 152 includes a light source and optical process units such as multiple reflection mirrors, so that these optical units can move in a horizontal direction (in other words, left and right directions) in FIG. 1. In the course of moving the optical components from left to right in FIG. 1, the light source emits the light. After a surface of the original document MS placed on the second exposure glass 154 reflects light, the reflected light is further reflected on multiple reflection mirrors until an image reading sensor 153 that is fixed to the scanner 150 receives the reflected light.

In contrast, the fixed reading units include the first fixed reading unit 151 disposed inside the scanner 150, and a second fixed reading unit 156 (see FIG. 4) disposed inside the ADF 51. The first fixed reading unit 151 includes a light source, multiple reflection mirrors, and the image reading sensor 153 such as CCD. The first fixed reading unit 151 is disposed immediately below a first exposure glass 155 (FIG. 4) that is fixed to the upper wall of the casing of the scanner 150, so that the first exposure glass 155 contacts the original document MS. When the sheet-like original document MS that is conveyed by the ADF 51 (described below) passes over the first exposure glass 155, the light source emits light. After a document face of the original document MS sequentially reflects the light emitted from the light source, the reflected light is further reflected on multiple reflection mirrors until the image reading sensor 153 receives the reflected light. By so doing, the first face of the original document MS is scanned without moving the optical components such as the light source and the multiple reflection mirrors. Further, the second fixed reading unit 156 scans or reads the second side or the back face of the original document MS after the original document MS has passed the first fixed reading unit 151.

The ADF 51 that is disposed on the scanner 150 includes a body cover 52, a document loading tray 53, a document conveyance unit 54, and a document stacking table 55. The body cover 52 holds and supports the document loading tray 53. The document loading tray 53 loads the original document MS to be read. The ADF 51 also holds and supports the document conveyance unit 54 and the document stacking table 55. The document conveyance unit 54 conveys the original document MS as a sheet member. The document stacking table 55 receives and stacks the original document MS after the original document MS is read.

FIG. 4 is a perspective view of the scanner 150 and the ADF 51 of the copier 500 according to the present embodiment.

As illustrated in FIG. 4, the ADF 51 is supported to be movable in the upward and downward directions by hinges 159 each being fixed to the scanner 150. With the rotation of the ADF 51 in the upward and downward directions, the ADF 51 works as an opening door, so that the first exposure glass 155 and the second exposure glass 154 on the upper face of the scanner 150 are exposed while the ADF 51 is open. In a case of the one-sided bound documents such as a book of a document bundle bounded on one-side, the original documents MS are not separated one by one. For this reason, the original documents MS in the above-described form are not conveyed by the ADF 51. When reading the one-sided bound documents, the ADF 51 is opened as illustrated in FIG. 4. After the ADF 51 is opened as illustrated in FIG. 4, the one-sided bound documents are placed on the second exposure glass 154 with a page to be read facing down. Then, the ADF 51 is closed. Then, the scanner 150 causes the movable reading unit 152 to read the image on the page of the one-sided bound documents placed facedown.

On the other hand, when the original documents MS are in a form of a document bundle of simply accumulated individual original documents MS, the original documents MS are sequentially read by the first fixed reading unit 151 in the scanner 150 and the second fixed reading unit 156 in the ADF 51 while the ADF 51 automatically conveys the original documents MS one by one.

In this case, a copy start key 158 is pressed after the bundle of original documents is placed on the document loading tray 53 of the ADF 51. Then, the ADF 51 starts conveyance of the original documents MS that are a bundle of original documents stacked on the document loading tray 53 to convey the original documents MS sequentially from top of the bundle of original documents MS to the document conveyance unit 54 one by one, and further convey the original documents MS to the document stacking table 55 while reversing the original document MS. In the course of this conveyance of the original documents MS, immediately after the original document MS is reversed, the original document MS is caused to pass immediately above the first fixed reading unit 151 of the scanner 150. At this time, the image on the first face of the original document MS is read by the first fixed reading unit 151 of the scanner 150.

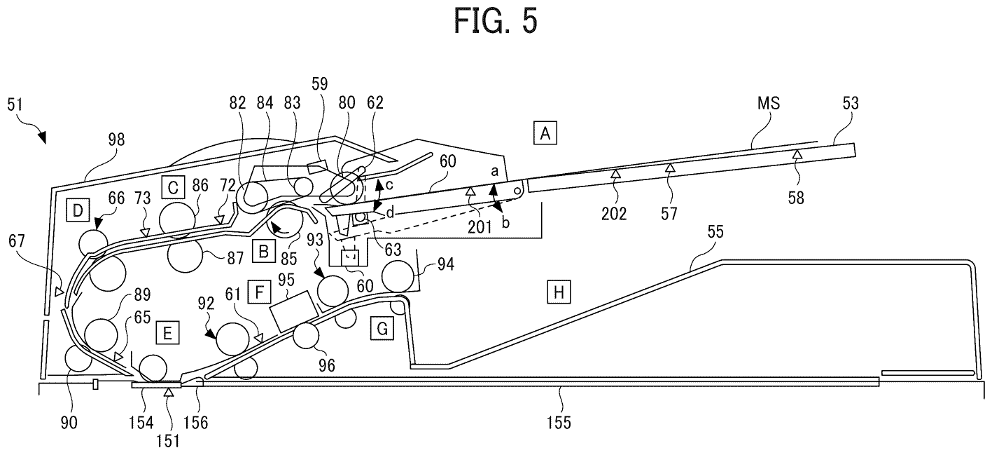

FIG. 5 is an enlarged view of the main part of the ADF 51 and the upper part of the scanner 150 of FIG. 4.

The ADF 51 according to the present embodiment includes, for example, a document setting part A, a document separating and feeding part B, a registration part C, a document turning part D, a first reading and conveying part E, a second reading and conveying part F, a document ejecting part G, and a document stacking part H. Further, the ADF 51 includes a document conveyance path for conveying the original document MS from the document loading tray 53 toward the first fixed reading unit 151 that is an image reading position.

The document setting part A has a document loading tray 53 on which a bundle of original documents MS is placed. The document separating and feeding part B separates and feeds the original document MS one by one from the bundle of the original documents MS set on the document loading tray 53. In the registration part C, the original document MS fed from the document separating and conveying part B temporarily contacts the original document MS to be aligned and fed again. The document turning part D has a conveyance passage curved in a C-shape, and turns the original document MS to be conveyed in the curved conveyance passage so as to reverse the original document MS upside down while turning the original document MS. Then, in the first reading and conveying part E, the first fixed reading unit 151 disposed in the scanner below the first exposure glass 155 as illustrated in FIG. 5 reads the first face of the original document MS while the original document MS is being conveyed on the first exposure glass 155. Further, in the second reading and conveying part F, the second fixed reading unit 95 reads the second face of the original document MS while the original document MS is conveyed under the second fixed reading unit 95. After the images on both sides of the original document MS are read, the original document MS is conveyed in the document ejecting part G to be ejected toward the document stacking part H. In the document stacking part H, the original documents MS are placed and stacked on the document stacking table 55.

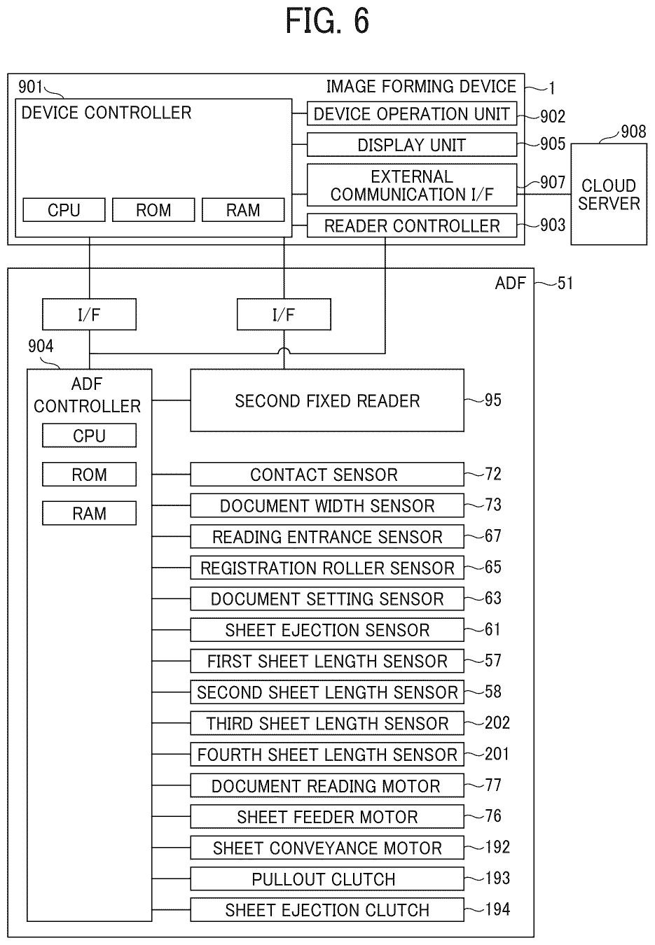

The original document MS is set in the document setting part A with the leading end of the original document MS placed on the movable document table 60 serving as a sheet tray pivotable in the directions indicated by arrows “a” and “b” in FIG. 5 depending on the thicknesses of a bundle of the original documents MS and the trailing end of the original document MS placed on the document loading tray 53. The side guides of the document loading tray 53 contact both lateral side ends of the original document MS in the width direction (i.e., the direction orthogonal to the drawing sheet) to adjust the position of the original document MS in the width direction. The original documents MS thus set push up a lever 62 that is rotatably disposed above the movable document table 60. Along with this movement of the original documents MS, the document set sensor 63 detects the setting of the original documents MS, and transmits the detection signal to the ADF controller 904 (see FIG. 6). The detection signal is then transmitted from the ADF controller 904 to a scanner controller 903 (see FIG. 6) of the scanner 150 via an interface (I/F).

A first length sensor 57, a second length sensor 58, a third length sensor 202, and a fourth length sensor 201 are held on the document loading tray 53. Each of the first length sensor 57, the second length sensor 58, the third length sensor 202, and the fourth length sensor 201 includes a reflective photosensor or an actuator-type sensor for detecting the length of the original document MS in the conveyance direction of the original document MS. The third length sensor 202 is, for example, a length sensor for a check. The fourth length sensor 201 is, for example, a length sensor for a business card. A description is given below of an example of the third length sensor 202 as a length sensor for a check and the fourth length sensor 201 as a length sensor for a business card.

The first length sensor 57, the second length sensor 58, the third length sensor 202, and the fourth length sensor 201 detect the length of the original document MS in the conveyance direction of the original document MS. The third length sensor 202 is disposed at a position where the third length sensor 202 is slightly not turned on when the check is placed on the document tray. The fourth length sensor 201 is arranged at a position where the fourth length sensor 201 is slightly not turned on when the business card is placed on the document tray.

Whether an original document of specified size such as a business card or a check is placed is detected from the detection information of the first length sensor 57, the second length sensor 58, the third length sensor 202, and the fourth length sensor 201. Since the length of a check is 185 mm and the length of a business card is 91 mm, the rough indication of the position of the third length sensor 202 is approximately 190 mm and the rough indication of the position of the fourth length sensor 201 is approximately 96 mm, with reference to the fence against which the leading end of the document set on the document tray contacts.

The pickup roller 80 is supported by the cam mechanism to be movable in the vertical direction (i.e., the directions indicated by arrows “c” and “d” in FIG. 5) and is disposed above the bundle of original documents MS stacked on the movable document table 60. The cam mechanism is driven by the pickup motor 56 to move the pickup roller 80 in the vertical direction. As the pickup roller 80 moves upward, the movable document table 60 rotates in the direction indicated by arrow “a” in FIG. 5, so that the pickup roller 80 is brought to contact the uppermost original document MS placed on top of the bundle of original documents MS.

As the movable document table 60 further moves upward, a table elevation detection sensor 59 detects that the movable document table 60 moves up to the maximum height. In response to this detection, the pickup motor 56 stops driving to stop the movable document table 60 from moving up.

The device operation unit 902 including a numeric keypad 160 and a display 161 mounted on the housing of the copier 500 is operated by the user (operator) to perform, for example, a key operation for setting a reading mode indicating a double-sided reading mode or a single-sided reading mode and a pressing operation of the copy start key 158. As the copy start key 158 is pressed by the user, the document feeding signal is sent to the ADF controller 904 of the ADF 51 from the device controller 901 (see FIG. 6). In response to the sending of the document feeding signal, the pickup roller 80 is rotated along with the forward rotation of the sheet feed motor 76, so that the original documents MS on the movable document table 60 are fed from the movable document table 60.

The setting of the double-sided reading mode or the single-sided reading mode collectively covers the whole original documents MS stacked on the movable document table 60. To be more specific, when the double-sided reading mode or the single-sided reading mode is set, both sides or a single-side of the whole original documents MS stacked on the movable document table 60 can be read. In addition, individual reading mode setting can be performed on separate ones of the original documents MS. For example, the double-sided reading mode can be applied to the first and 10th original documents MS and the single-sided reading mode can be applied to the other original documents MS.

The original document MS fed by the pickup roller 80 enters the document separating and feeding part B to be fed to the contact position with the sheet feed belt 84. The sheet feed belt 84 is wound and stretched by, for example, a drive roller 82 to be endlessly moved in the clockwise direction in FIG. 5 by rotation of the drive roller 82 along with the forward rotation of the sheet feed motor 76. A separation roller 85 is in contact with the lower stretched face of the sheet feed belt 84 to be rotated in the clockwise direction in FIG. 5 along with the forward rotation of the sheet feed motor 76. At the contact portion, the sheet feed belt 84 is rotated so that the surface of the sheet feed belt 84 moves in the conveyance direction of the original document MS. The separation roller 85 is pressed against the sheet feed belt 84 with a predetermined pressure. When the separation roller 85 directly contacts the sheet feed belt 84 or a single original document MS is nipped in the contact portion, the separation roller 85 is rotated with rotation of the sheet feed belt 84 or movement of the original document MS. However, when multiple original documents MS are nipped in the contact portion, the force of the separation roller 85 to be rotated with rotation of the sheet feed belt 84 or movement of the original document MS is lower than the torque of a torque limiter. For this reason, the separation roller 85 is rotated in the clockwise direction that is opposite to a direction in which the separation roller 85 is rotated. As a result, the separation roller 85 applies the force of movement in the direction opposite to the sheet conveyance direction, to the original documents MS under the uppermost original document MS, so that the uppermost original document MS along is separated from the multiple original documents MS under the uppermost original document MS. The above-described operation is referred to as a sheet feeding and separating operation.

The original document MS is separated from the other original documents MS through the operations of the sheet feed belt 84 and the separation roller 85, and enters the registration part C. Then, the leading end of the original document MS is detected by the document contact sensor 72 when the original document MS passes directly under the document contact sensor 72. At this time, the pickup roller 80 receiving the driving force of the pickup motor 56 is still rotating. However, as the pickup roller 80 is separated from the original document MS due to descendance of the movable document table 60, the original document MS is conveyed only by an endless moving force of the sheet feed belt 84. Then, the endless movement of the sheet feed belt 84 is continued for a given time from the timing at which the leading end of the original document MS is detected by the document contact sensor 72. Then, the leading end of the original document MS contacts the contact portion of the pullout driven roller 87 and the pullout drive roller 86 that rotates while contacting the pullout drive roller 86. At this time, the contact portion of the pullout driven roller 87 and the pullout drive roller 86 is separated from the original document MS, from the timing at which the leading end of the original document MS is detected by the document contact sensor 72. By so doing, the timing to start conveying the original document MS by the endless movement force of the sheet feed belt 84 alone can be increased or decreased. By increasing or decreasing the timing to start conveying the original document MS by the endless movement force of the sheet feed belt 84 alone, the contact amount of the original document MS to contact the contact portion with the pullout driven roller 87 can be adjusted.

If the speed of the original document MS at this time is 500 mm/s, the contact amount can be increased by 1 mm by delaying the timing to separate the contact portion from the original document MS by 2 msec. The equation is expressed by (500 mm/s×0.002 sec=1 mm).

The pullout driven roller 87 has a function of conveying the original document MS to the intermediate roller pair 66 downstream from the pullout driven roller 87 in the document conveyance direction, and is driven and rotated by the rotation of the sheet feed motor 76 in the reverse direction. As the sheet feed motor 76 rotates in the reverse direction, the pullout driven roller 87 and one roller of the intermediate roller pair 66 contacting the pullout driven roller 87 start rotating and the endless movement of the sheet feed belt 84 stops. At this time, the pickup roller 80 stops rotating.

The original document MS that is fed by the pullout driven roller 87 passes directly under the document width sensor 73. The document width sensor 73 includes multiple sheet detectors each including a reflective photosensor. The multiple sheet detectors are aligned in a row in the width direction of the original document MS (i.e., the direction perpendicular to the drawing sheet of FIG. 5). The size of the original document MS in the width direction is detected based on which one of the multiple document detectors detects the original document MS. The length of the original document MS in the document conveyance direction is detected based on the time from when the leading end of the original document MS is detected by the document contact sensor 72 to when the trailing end of the original document MS is not detected by the document contact sensor 72.

The leading end of the original document MS whose size in the width direction is detected by the document width sensor 73 enters the document turning part D and is nipped by the contact portion between the rollers of the intermediate roller pair 66. The conveyance speed of the original document MS conveyed by the intermediate roller pair 66 is set faster than the conveyance speed of the original document MS in the first reading and conveying part E that will be described below. This configuration achieves a reduction in time for conveying the original document MS to the first reading and conveying part E.

As described above, the size of an original document MS can be detected by the document width sensor 73, the first length sensor 57, the second length sensor 58, the third length sensor 202, and the fourth length sensor 201. On the other hand, the user can also designate the size (reading size) of the original document MS with the device operation unit 902. For example, the user can select and designate the sizes of business cards (55 mm×91 mm) and checks (85 mm×185 mm) from among options for all sizes.

The leading end of the original document MS conveyed in the document turning part D passes through a position where the leading end of the original document MS faces a scan entrance sensor 67. As a result, when the leading end of the original document MS is detected by the scan entrance sensor 67, the conveyance speed of the original document MS by the intermediate roller pair 66 is reduced until the leading end of the original document MS is conveyed to the position of the scan entrance roller pair (including rollers 89 and 90) downstream from the scan entrance sensor 67 in the conveyance direction of the original document MS. As a document reading motor 77 (see FIG. 6) starts to drive and rotate, one roller of the scan entrance roller pair, one roller of a first scan exit roller pair 92, and one roller of a second scan exit roller pair 93 respectively start the rotations.

In the document turning part D, while the original document MS is conveyed in the curved conveyance passage between the intermediate roller pair 66 and the scan entrance roller pair, the upper and lower faces of the original document MS are reversed, and the conveyance direction of the original document MS is turned back. Then, the leading end of the original document MS that has passed through the nip region between the rollers of the scan entrance roller pair passes directly under the registration sensor 65. The operation up to this point after the sheet feeding and separating operation is referred to as a “document pullout operation”.

When the registration sensor 65 detects the leading end of the original document MS, the conveyance speed of the original document MS is gradually decreased through the given conveyance distance. Then, the rotations of the pullout drive roller 86 and the intermediate roller pair 66 are stopped due to the stop of the sheet conveyance motor 192 (see FIG. 6), and the rotation of the scan entrance roller pair is stopped due to the stop of the document reading motor 77. Due to this action, the conveyance of the original document MS is temporarily stopped at the registration position before the first reading and conveying part E. Further, a registration stop signal is sent to the scanner controller 903.

FIG. 6 is a block diagram illustrating a part of an electric circuit in the copier 500 according to an embodiment of the present disclosure.

The electric circuit of the copier 500 includes, for example, the device controller 901 of the image forming device 1, the scanner controller 903 of the scanner 150, and the ADF controller 904 of the ADF 51. The device controller 901 of the image forming device 1 and the scanner controller 903 of the scanner 150 include, for example, a central processing unit (CPU), a random access memory (RAM), and a read-only memory (ROM). Further, the ADF controller 904 of the ADF 51 includes, for example, a CPU, a RAM, and a ROM. The device controller 901 and the scanner controller 903 are connected to communicate with each other. The scanner controller 903 and the ADF controller 904 are connected to communicate with each other. The ADF controller 904 and the device controller 901 are connected to communicate with each other.

The sheet conveyance motor 192 connected to the ADF controller 904 is a rotation drive source for the pullout drive roller 86 and the document ejection roller pair 94 in the ADF 51. Further, the pullout clutch 193 connected to the ADF controller 904 connects and disconnects the rotation driving force of the sheet conveyance motor 192 to and from the pullout drive roller 86. Further, the sheet ejection clutch 194 connects and disconnects the rotation drive force of the sheet conveyance motor 192 to and from the document ejection roller pair 94 as a feeding and conveying device.

After receiving the registration stop signal from the ADF controller 904, the scanner controller 903 sends the reading start signal as a sheet feed permission signal to the ADF controller 904. After receiving the reading start signal as a sheet feed permission signal, the ADF controller 904 restarts the rotations of the sheet conveyance motor 192 and the document reading motor 77. Then, the timing at which the leading end of the original document MS reaches the reading position of the first fixed reading unit 151 is calculated based on the pulse counts of the document reading motor 77. At this timing, the ADF controller 904 sends a gate signal indicating an effective image area of the first face of the original document MS in the sub-scanning direction, to the scanner controller 903. The ADF controller 904 continues sending the gate signal to the scanner controller 903 until the trailing end of the original document MS passes through the reading position of the first fixed reading unit 151, so that the first face of the original document MS is scanned by the first fixed reading unit 151.

The original document MS that has passed through the first reading and conveying part E passes through the first scan exit roller pair 92. Then, the leading end of the original document MS is detected by the document ejection sensor 61. When the single-sided reading mode is set, the second face of the original document MS is not to be read by the second fixed reading unit 95. Then, when the leading end of the original document MS is detected by the document ejection sensor 61, the sheet ejection clutch 194 connects the driving force of the sheet conveyance motor 192 to the document ejection roller pair 94. The timing at which the trailing end of the original document MS passes through the nip region of the document ejection roller pair 94 is calculated based on the pulse count of the sheet conveyance motor after the detection of the leading end of the original document MS by the document ejection sensor 61. Then, based on this calculation result, the sheet ejection clutch 194 is stopped.

On the other hand, when the double-sided reading mode is set, the document ejection sensor 61 initially detects the leading end of the original document MS. Then, the timing of the period to which the original document MS reaches the second fixed reading unit 95 is calculated based on the pulse counts of the document reading motor 77. Then, at the timing at which the calculation result is obtained, the ADF controller 904 sends a gate signal indicating the effective image area of the second face of the original document MS in the sub-scanning direction, to the scanner controller 903. The ADF controller 904 continues sending the gate signal to the scanner controller 903 until the trailing end of the original document MS passes through the reading position of the second fixed reading unit 95, so that the second face of the original document MS is scanned by the second fixed reading unit 95.

The second fixed reading unit 95 includes contact-type image sensors (CIS) and is coated on the reading face for the purpose of preventing reading vertical streaks due to the paste-like foreign substance adhering to the original document MS to adhere to the reading face of the second fixed reading unit 95. A second reading roller 96 as a document supporter that supports the original document MS from a non-reading face is disposed at a position facing the second fixed reading unit 95. The second reading roller 96 functions as a floating retainer that prevents the original document MS from floating up at the reading position by the second fixed reading unit 95 and as a reference white portion for acquiring in the shading data on the second fixed reading unit 95.

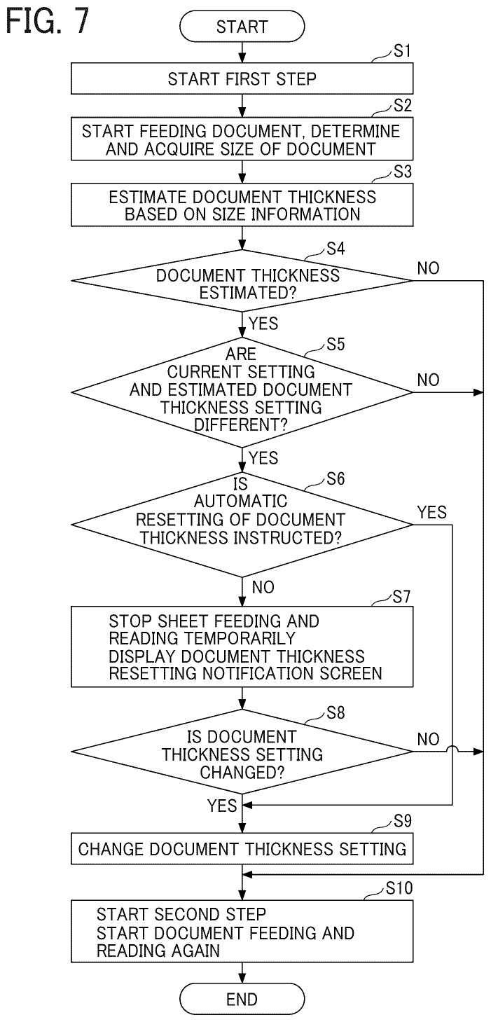

FIG. 7 is a flowchart of an example of the document thickness setting change and the reading operation when the sheet thickness of an original document is estimated from size information.

In step S1, the user presses the copy start key 158 or the scan start button with an original document to be copied or scanned is set on the document tray. The ADF 51 as an example of a document processing apparatus starts the process of the first step. The first step is a sheet (document) feeding and reading operation including a process of estimating the thickness or kind of the sheet (document).

In step S2, the ADF controller 904 of the ADF 51 starts feeding the original document. The ADF controller 904 included in the ADF 51 determines the size of the original document by using the detection information of the document width sensor 73, the first length sensor 57, the second length sensor 58, the third length sensor 202, and the fourth length sensor 201. The ADF controller 904 also acquires, from the image forming device 1, the size of the original document (user setting) designated by the user via the device operation unit 902.

In step S3, the ADF controller 904 estimates the thickness or kind of the original document from the determined or acquired size of the original document. The reason for the estimation in step S3 is that, for example, a specific type of original documents such as business cards, checks, or receipts has the determined size, thickness (e.g., thick paper for business cards, thin paper for checks and receipts), and kind, and the size of the original document can be a piece of information from which the thickness or kind of an original document can be determined with a high probability based on experience.

In the present embodiment, business cards (substantially applied to thick paper) and checks (substantially applied to thin paper) are handled, but if there is any original document having a specific type other than business cards and checks that can determine the thickness or kind of the original document, the thickness and kind of the original document can be specified in the same way as for business cards and checks. A description is given below of an example of specifying the thickness of an original document.

In step S4, the ADF controller 904 branches the process depending on whether the thickness of the original document can be estimated or not. The branching of the process is because, unlike business cards or checks, it is not likely that each document thickness is constantly estimated from the information of the size of the original document, depending on the size of the document.

When the thickness of the original document is not estimated (NO in step S4), the ADF controller 904 does not change the document thickness information that is currently set, and the process proceeds to step S10 where the sheet feeding and reading operation in the second step. The second step is the sheet (document) feeding and reading operation that does not include a process a paper feeding and reading operation that does not include the process of estimating the thickness or kind of the sheet (document). In contrast, when the thickness of the original document is estimated (YES in step S4), the ADF controller 904 proceeds to step S5 to compare the document thickness obtained by the estimation and the document thickness currently set in the document thickness information. In other words, in step S5, the ADF controller 904 determines whether the current setting and the estimated document thickness setting are different.

When the document thickness obtained by the estimation and the document thickness currently set in the document thickness information are the same (NO in step S5), the document thickness information is not changed because the document thickness currently set in the document thickness information does not need to be reset, the process proceeds to the sheet feeding and reading operation in the second step of step S10.

When the document thickness obtained by the estimation and the document thickness currently set in the document thickness information are different (YES in step S5), the ADF controller 904 determines that it is highly likely that the user made a wrong setting of the document thickness to the document thickness information, and proceeds the process to step S6.

In step S6, the ADF controller 904 determines whether the automatic resetting of the document thickness of an original document is permitted (instructed). When the automatic resetting of the document thicknesses is permitted (YES in step S6), the ADF controller 904 proceeds the process to step S9 to reset (change) the paper thicknesses set in the document thickness information. Subsequently, in step S10, the ADF controller 904 starts the sheet feeding and reading operation with the conveyance control amount optimum for the document thickness set in the document thickness information after the change.

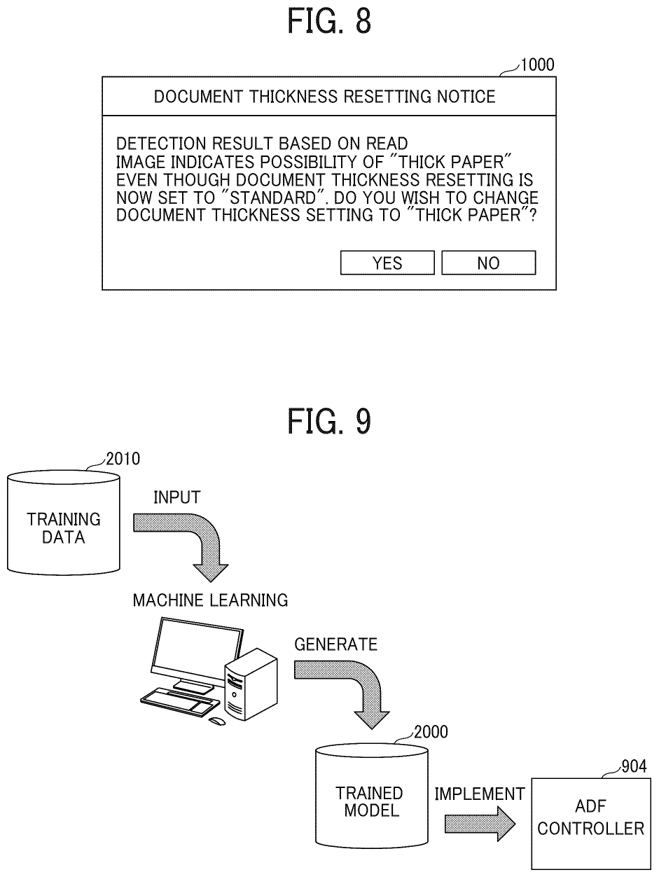

When the automatic resetting of the document thicknesses is not permitted (NO in step S6), the ADF controller 904 proceeds the process to step S7 to temporarily stop the sheet feeding and reading operation. The ADF controller 904, for example, a document thickness resetting notification screen 1000 illustrated in FIG. 8 on the display 905, prompts the user to confirm the setting, and causes the user to input whether or not to reset (change) the document thickness set in the document thickness information. The document thickness resetting notification screen 1000 of FIG. 8 is displayed when the ADF controller 904 determines that the matching degree (described below) exceeds the threshold value, and that the document thickness setting is not correct. The document thickness resetting notification screen 1000 of FIG. 8 can make the user aware of error or omission of the document thickness setting, and can make the user perform the correct document thickness setting.

The detailed description of the document thickness resetting notification screen 1000 is described below.

In step S8, the ADF controller 904 determines whether the document thickness of the original document set in the document thickness information is reset (changed), in other words, whether the user reset (change) the document thickness setting. When the user does not reset (change) the document thickness of the original document set in the document thickness information (NO in step S8), the ADF controller 904 proceeds the process to step S10 to perform the sheet feeding and reading operation in the second step. In contrast, when the user resets (changes) the document thickness of the original document set in the document thickness information (YES in step S8), the ADF controller 904 proceeds the process to step S9 to change the document thickness set in the document thickness information. Subsequently, in step S10, the ADF controller 904 starts the sheet feeding and reading operation with the conveyance control amount optimum for the document thickness set in the document thickness information after the change.

A description is given below of a generation step of the trained model 2000 through machine learning, according to the present embodiment.

FIG. 9 is a diagram illustrating an example of a generation step of the trained model 2000 by machine learning.

In the present embodiment, the trained model 2000 generated by machine learning is implemented in the control program written in the ADF controller 904 of the ADF 51 that is an example of a document processing apparatus.

The trained model 2000 is generated by analyzing the training data 2010 created from data collected by using an external personal computer (PC) or a cloud server 908 illustrated in FIG. 6 that can generate the trained model 2000. The trained model 2000 is a kind of calculation algorithm, and is implemented as a module as a part of a control program. Although FIG. 9 illustrates a case where the trained model 2000 is implemented in the ADF controller 904 of the ADF 51, the trained model 2000 may be implemented in the device controller 901 of the image forming device 1 or may be implemented in the cloud server 908 that can communicate via a network by an external communication interface (I/F) 907 in FIG. 6. A detailed description will be given below of how to use the trained model 2000 implemented as a control program. The ADF controller 904 that executes the control program functions as a control amount determination unit and an estimation unit. The ADF controller 904 that executes the control program may function as a notification unit, an input unit, and a document information acquisition unit.

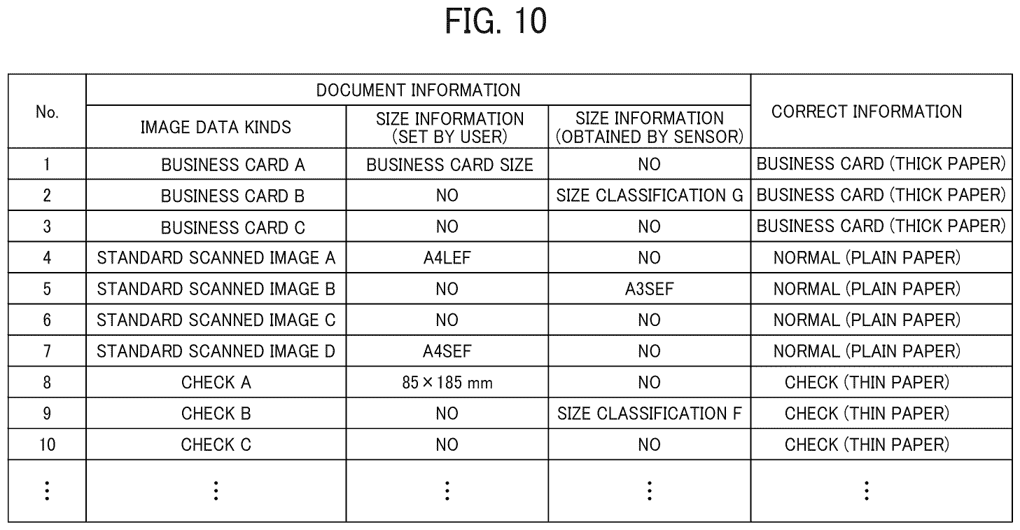

FIG. 10 is a diagram illustrating an example of the training data 2010 analyzed by machine learning.

In the present embodiment, the training data 2010 is are analyzed with input data and output data by machine learning, where the input data includes image data kinds as document information for reading (scanning) and size information, and the output data includes the document thickness that is correct answer information to be predicted in the inference step. As multiple classifications of the document, the document thickness (thick paper, plain paper, and thin paper) is described in FIG. 10. The multiple classifications of the document may include a document kind (plain paper, coated paper, and carbon paper) in addition to the document thickness. In the present embodiment, an example that the multiple classification of the document includes the document thickness is described.

In the training data 2010 of FIG. 10, the input data and the output data are set focusing on the document thickness, but the analysis can be made by machine learning if the image data kind and the size information for each document kind are prepared as the document information in the same manner for the document kind.

The reason why the size information (set by the user) and the size information (information obtained by the sensor) are added to the document information in addition to the image data kind is that, for example, business cards that are often thick paper, and checks or receipts that are often thin paper have various fixed sizes, and the size information can be a piece of information for determining the document thickness more accurately than the image data kind.

A description is given below of an inference step using the trained model 2000 obtained by machine learning, according to the present embodiment.

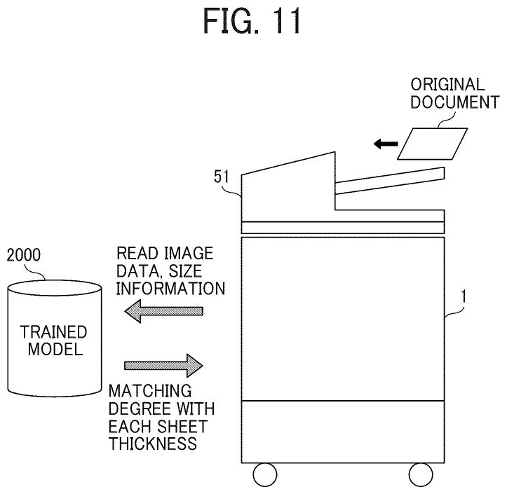

FIG. 11 is a diagram illustrating an example of an inference step using the trained model 2000 obtained by machine learning.

In the present embodiment, when actually reading an original document, the sheet thickness of the original document is predicted by the trained model 2000 generated through machine learning. In the inference step, the document information (size information) set by the image forming device 1 and the read image data are input to the trained model 2000 as input data, and the matching degree (similarity) with each sheet thickness (e.g., thick paper, plain paper, thin paper) is received as output data.

In the control program written in the ADF controller 904, the optimum sheet feed and conveyance control amounts are set in advance for each sheet thickness of the original document so that skew and sheet feed failure are less likely to occur.

The ADF controller 904 that causes the control program to determine whether the matching degree with each sheet thickness output from the trained model 2000 matches with the sheet thickness set by the user. If the sheet thickness inferred from the matching degree with each sheet thickness output from the trained model 2000 is different from the sheet thickness set by the user, the ADF controller 904 automatically changes the setting to the sheet thickness with a high matching degree, or notifies the user to promptly change the setting of the sheet thickness, and changes the conveyance control amount of the original document.

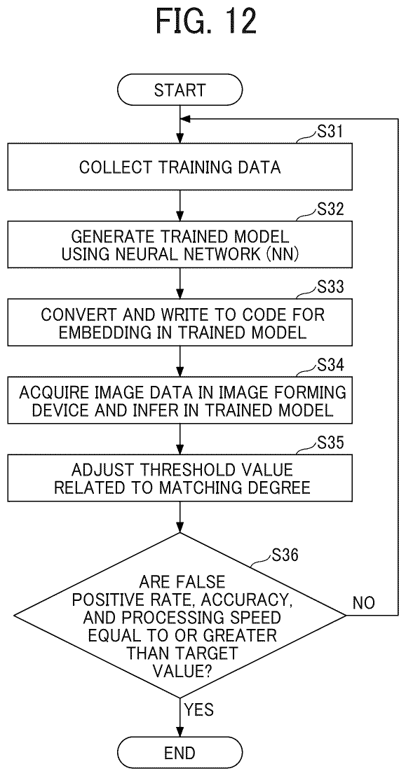

FIG. 12 is a flowchart of an example of specific steps to completion of the trained model 2000 generated by deep learning (DL) using neural network (NN).

In step S31, the designer collects the training data 2010. For example, the designer reads an original document using the ADF 51, and keeps a set of the data of the scanned images, the type of the original document used (sheet thickness), the size information (set by the user), and the size information (information obtained by the sensor). The classification (sheet thickness) of the original documents used is correct answer information to be inferred, and is labeling data.

It is desirable to use the training data 2010 that is highly likely to be actually used by the user. Accordingly, it is most preferable that the user can be provided with the classification and the size information of the original document read at the actual site such as an office, and the scanned image data.

If the designer fails to receive the image data, the designer may prepare a large amount of data of the image data collected on the web and the classification (sheet thickness) of the original document that is empirically assumed to correspond to the image data (for example, a dataset of image data in which the content of a business card is drawn+“thick paper” information, or a dataset of image data in which the content of a check is drawn+“thin paper” information). In deep learning, it is better to use a larger number of the training data 2010. For this reason, it is preferable to collect as many datasets as possible in step S1.

In step S32, the designer uses the training data 2010 collected in step S31 and generates the trained model 2000 by deep learning using the neural network. The trained model 2000 can be generated by using a general AI framework. The AI framework can utilize, for example, TensorFlow®, MATLAB®, PyTorch®, and ONNX®.

The trained model 2000 generated by the AI framework is often not in a format that can be processed by the CPUs of the ADF 51 or the image forming device 1, and thus, in step S33, the trained model 2000 is converted into an embedded code (mainly, C language) and written to a board in which the CPUs are embedded.

The conversion into the embedded code can be performed by using a conversion tool provided by a vendor of the CPU. When a unique CPU is used, the conversion into an embedded code by a unique method may be required.

When executing the inference step using the trained model 2000 by a server on the cloud such as the cloud server 908 instead of the embedded CPUs, the conversion and writing into the embedded code in step S33 are not to be performed. When executing the inference step using the trained model 2000 by a server on the cloud such as the cloud server 908 instead of the embedded CPUs, the conversion into a format executable on the cloud server 908 may be performed instead of skipping the conversion and writing into the embedded code. If the conversion into a format executable on the cloud server 908 is required, the conversion is performed.

In step S34, with the trained model 2000 after conversion being implemented, the ADF controller 904 of the ADF 51 or the device controller 901 of the image forming device 1 executes an actual inference step, outputs the matching degree for each document thickness, and records the processing time actually required for the operation. The original document to be read in step S34 is not the original document read in step S31, and needs to be new to the trained model 2000.

In step S34, the designer collects a certain number (hundreds or thousands) of datasets including the matching degrees and the processing speeds. In step S35, the designer collects the collected data and adjusts the threshold value of the matching degree.

In step S36, the designer determines whether the trained model may be implemented to a product based on whether the false detection rate, the correct answer rate, and the processing speed are equal to or higher than the target values. If the threshold value to be adjusted in step S35 is set with a high level, the result comes with a low false detection rate and a low correct answer rate. If the threshold value to be adjusted in step S35 is set with low level, the result comes with a high false detection rate and a high correct answer rate. This relation is a trade-off. For this reason, the threshold value is determined in consideration of the trade-off relation.

When the false detection rate is set to be less than the target value of 1%, for example, and the detection of thick paper results in plain paper or thin paper at a rate of one or more cases out of 100 cases, the process returns to step S31, and the collection of the training data 2010 is executed again. The correct answer rate is also determined in addition to the false detection rate, and the target value is set for each document thickness such that the probability of detecting thick paper as thick paper is 80% or more or the probability of detecting thin paper as thin paper is 70% or more. If the target values are not satisfied, the process returns to step S31. Further, as for the processing speed, the target values are set, for example, such that the period of time from the acquisition of the image data to the generation of the matching degree by the inference is equal to or less than the average rate of 100 ms, and is equal to or less than the 150 msec at the maximum. When the target values are not achieved, the process returns to step S31. Finally, if the target values can be satisfied for each of the false detection rate, the correct answer rate, and the processing speed, the generation of the trained model 2000 that can be implemented in a product is completed.

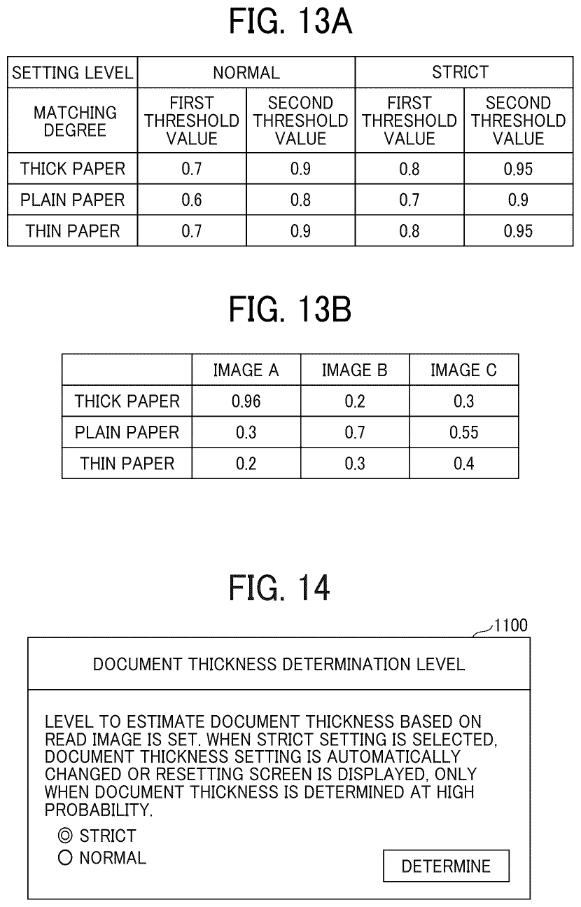

FIGS. 13A and 13B are diagrams each illustrating an example of the threshold values of the matching degrees and the estimation results.

FIG. 13A is a diagram illustrating an example of the setting of the threshold values of the matching degree.

As illustrated in FIG. 13A, a setting level (normal or strict) can be selected for the matching degree. The selection of the setting level is performed on the document thickness determination level setting screen 1100 illustrated in FIG. 14.

FIG. 14 is a diagram illustrating the document thickness determination level setting screen 1100.

A detailed description of the document thickness determination level setting screen 1100 is given below.

The threshold value is higher for the “strict” setting level than for the “normal” setting level.

FIG. 13B illustrates the result when the matching degree of document information (document thickness only in the table) regarding images A, B and C is estimated by the trained model 2000.

The image A has the highest matching degree “0.96” for thick paper, and exceeds the first threshold value and the second threshold value at both the setting levels “normal” and “strict”. The image B has the highest degree of matching “0.7” for plain paper, and only exceeds the first threshold value of the setting level “normal”. The image C does not have a high matching degree with any paper thickness and none of the setting levels “normal” and “strict” exceeds the first threshold value and the second threshold value.

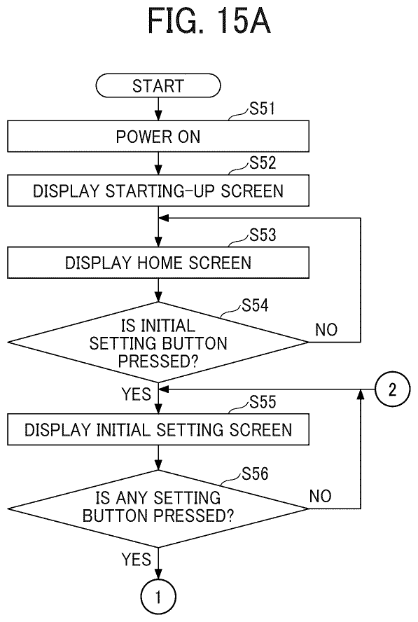

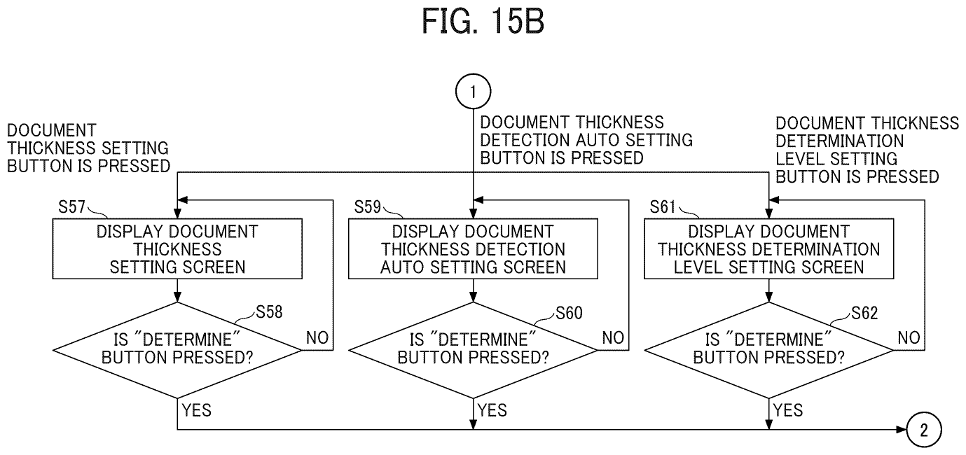

FIGS. 15A and 15B are the first and second parts of a flowchart of the screen transition according to an embodiment of the present disclosure.

The display and operation of the screen are performed using the display 905 and the device operation unit 902 illustrated in FIG. 6.

In step S51, the user turns on the power of the image forming device 1. In step S52, the display 905 of the image forming device 1 displays the screen indicating the image forming device 1 is starting up. When the startup of the image forming device 1 is completed, in step S53, the display 905 of the image forming device 1 displays the home screen. On the home screen, an initial setting button is arranged together with the mode selection button such as “copy” or “scan”.

In step S54, the initial setting button is pressed. In step S55, the display 905 of the image forming device 1 displays the initial setting screen. The initial setting screen is a screen on which various settings can be made for items to be set in advance in the operation such as copying or scanning in the image forming device 1.

Buttons such as “document thickness setting”, “document thickness detection auto setting”, and “document thickness determination level setting” are arranged on the initial setting screen, and the screen of each setting can be displayed by pressing each button.

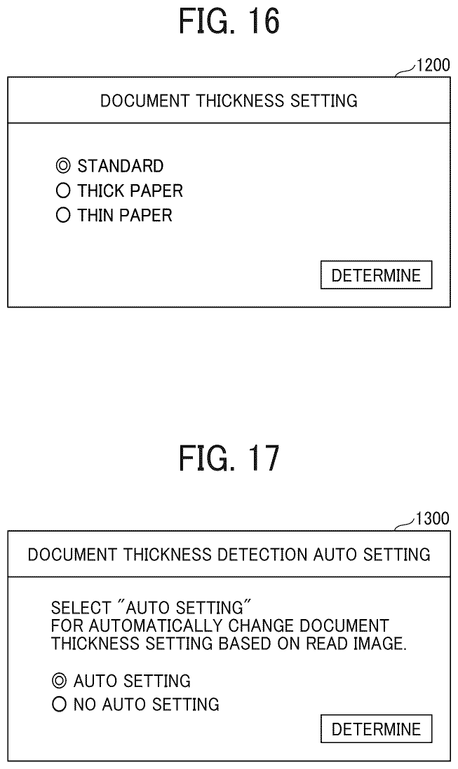

In step S56, it is determined whether any setting button is pressed. When the document thickness setting button on the initial setting screen is pressed in step S56, the process proceeds to step S57. In step S57, the document thickness setting screen 1200 illustrated in FIG. 16 is displayed on the display 905 of the image forming device 1. The document thickness setting screen 1200 allows the user or the operator to select the document thickness setting from standard paper, thick paper and thin paper, and the optimum sheet feeding and the optimum conveyance control amount are set in advance for each document thickness so as to prevent skew and sheet feed failure. The user sets the thicknesses of the original documents to be stacked on the ADF 51 before the start of reading the original documents on the document thickness setting screen 1200. If there is no error or omission of the setting in this step, the resetting of the document thickness by the trained model 2000 does not occur. In step S58, when the “determine” button of the document thickness setting screen 1200 is pressed, the display of the display 905 of the image forming device 1 returns to the initial setting screen.

When the document thickness detection auto setting button on the initial setting screen is pressed in step S56, the process proceeds to step S59. In step S59, the document thickness detection auto setting screen 1300 illustrated in FIG. 17 is displayed on the display 905 of the image forming device 1. The document thickness detection auto setting screen 1300 of FIG. 17 allows the user to set “auto setting” or “no auto setting”. When the user sets “auto setting” on the document thickness detection auto setting screen 1300 of FIG. 17, the document thickness setting is automatically performed without confirming with the user whether or not to perform the resetting as in the document thickness resetting notification screen 1000 of FIG. 8, for example. When the user sets “no auto setting” on the document thickness detection auto setting screen 1300 of FIG. 17, the user is requested to confirm whether or not to perform the resetting as in the document thickness resetting notification screen 1000 of FIG. 8, for example. In step S60, when the “determine” button of the document thickness detection auto setting screen 1300 is pressed, the display of the display 905 of the image forming device 1 returns to the initial setting screen.

When the document thickness determination level setting button on the initial setting screen is pressed in step S56, the process proceeds to step S61. In step S61, the document thickness determination level setting screen 1100 illustrated in FIG. 14 is displayed on the display 905 of the image forming device 1.

The document thickness determination level setting screen 1100 of FIG. 14 allows the setting level of the threshold value of the matching degree to be changed. In a case where the user sets the threshold value for the matching degree to a strict level (the user does not change the document thickness setting unless the matching degree is closer to 1), the user can change the document thickness setting or display the document thickness resetting notification screen 1000 only when the sheet thickness was determined with a high probability. In step S92, when the “determine” button of the document thickness determination level setting screen 1100 is pressed, the display of the display 905 of the image forming device 1 returns to the initial setting screen.

The settings made on the document thickness resetting notification screen 1000, the document thickness determination level setting screen 1100, the document thickness setting screen 1200 and the document thickness detection auto setting screen 1300 are stored in the ROM of the device controller 901 of the image forming device 1 at the time of determination, and remain even after the power is turned off.

Since the document thickness setting screen 1200 of FIG. 16 is considered to be frequently used by the user, a document thickness setting button for transitioning from the copy mode screen or the scan mode screen to the document thickness setting screen 1200 may be displayed separately.

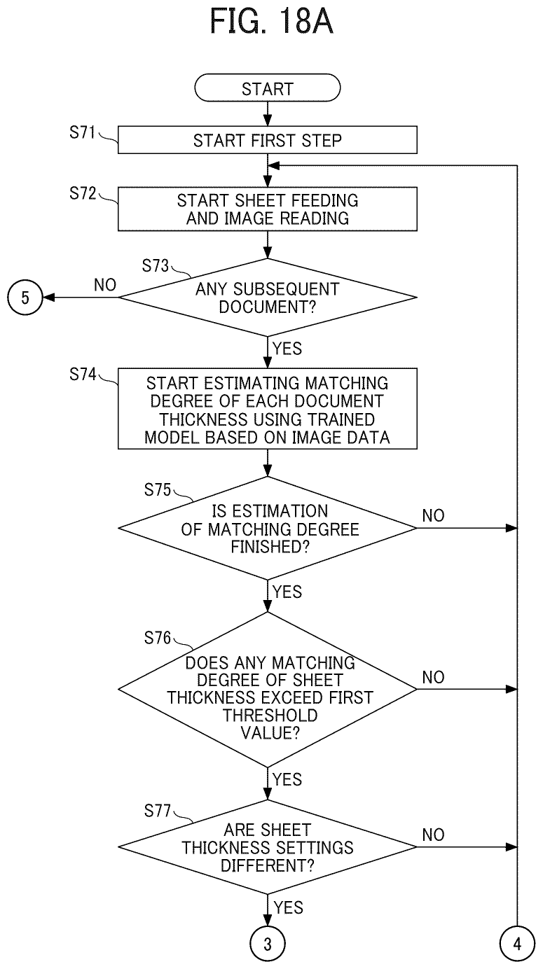

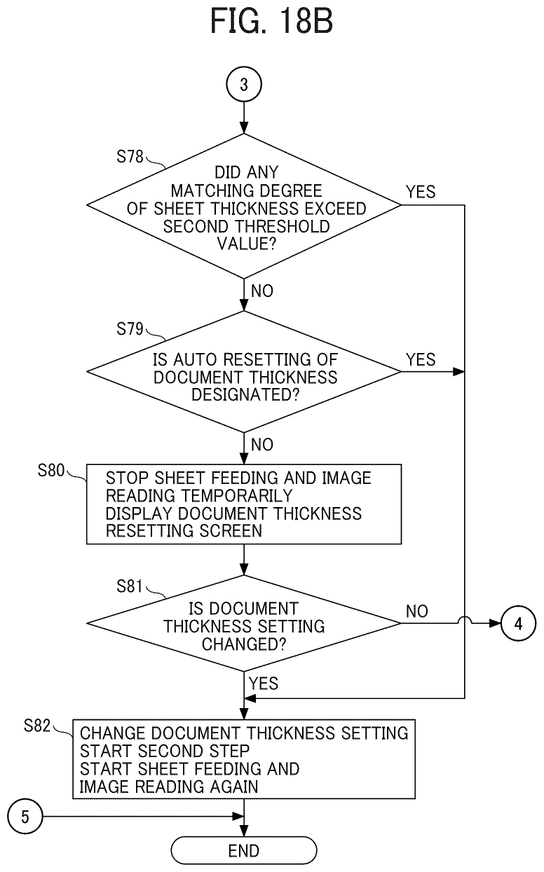

FIGS. 18A and 18B are the first and second parts of a flowchart of a process flow of the document thickness setting change and the reading operation using the trained model.

In step S71, the user presses the copy start key 158 or the scan start button with an original document to be copied or scanned is set on the document tray, and starts the first step in the ADF 51. In step S72, the ADF controller 904 of the ADF 51 starts the sheet feeding and reading operation as the first step.

In step S73, after the original document has been fed and the trailing end of the original document has passed the document set sensor 63, the ADF controller 904 of the ADF 51 determines with the document set sensor 63 whether the subsequent original document is placed on the document tray. When no subsequent original document is placed on the document tray (NO in step S73), the resetting of the thickness of the original document is required, and the ADF controller 904 of the ADF 51 does not estimate the matching degree for the respective sheet thicknesses of the original documents using the trained model 2000.

In contrast, when a subsequent original document is placed on the document tray (YES in step S73), in step S74, the ADF controller 904 of the ADF 51 starts estimating the matching degree with each sheet thickness using the trained model 2000 generated based on the image data scanned by the image reading unit disposed in the ADF 51 or the image forming device 1 as an input. In step S75, the ADF controller 904 of the ADF 51 determines whether the estimation of the matching degree is finished. When the ADF controller 904 of the ADF 51 determines that the estimation of the matching degree is finished (YES in step S75), the ADF controller 904 of the ADF 51 returns to step S72 to continue the sheet feeding and reading operation of the original document with the same setting. When it is determined that the estimation of the matching degree is finished in step S75, the ADF controller 904 of the ADF 51 proceeds the process to step S76.

In step S76, the ADF controller 904 of the ADF 51 determines whether the matching degree whose estimation has been finished exceeds the first threshold value in which the matching degree of any sheet thickness is set in advance. When the matching degree of any sheet thickness exceeds the first threshold value that is set in advance (YES in step S76), the process proceeds to step S77. In contrast, when the matching degree of any sheet thickness does not exceed the first threshold value that is set in advance (NO in step S76), the process returns to step S72 to continue the first step to perform the reading operation on the subsequent original document.

In step S77, the ADF controller 904 of the ADF 51 compares the sheet thickness that exceeds the first threshold value and the sheet thickness that is currently set to determine whether the sheet thickness settings are different from each other. When the sheet thickness settings are the same (NO in step S77), there is no need to reset the sheet thickness. For this reason, the ADF controller 904 of the ADF 51 returns to step S72 to continue the first step to perform the reading operation on the subsequent original document. In contrast, when the sheet thickness settings are different from each other (YES in step S77), the ADF controller 904 of the ADF 51 determines that it is highly likely that the user mistakenly makes the sheet thickness setting of the original document, and proceeds to step S78.

In step S78, the ADF controller 904 of the ADF 51 determines whether the matching degree of any sheet thickness exceeds the second threshold value that is set in advance. When the matching degree of any sheet thickness exceeds the second threshold value that is set in advance (YES in step S78), the process proceeds to step S82 to perform the resetting of the sheet thickness regardless of the automatic resetting of the sheet thickness to start the second step. The ADF controller 904 of the ADF 51 starts the sheet feeding and reading operation with the conveyance control amount optimum to the document thickness setting after the change. When no matching degree of any sheet thickness exceeds the second threshold value that is set in advance (NO in step S78), the process proceeds to step S79.

In step S79, the ADF controller 904 of the ADF 51 determines whether the automatic resetting of the sheet thickness (document thickness) is designated. When the automatic resetting of the sheet thickness (document thickness) is designated (YES in step S79), the ADF controller 904 of the ADF 51 proceeds the process to step S82 to reset the sheet thickness to start the second step. The ADF controller 904 of the ADF 51 starts the sheet feeding and reading operation with the conveyance control amount optimum to the document thickness setting after the change.

In contrast, when the automatic resetting of the sheet thickness (document thickness) is not designated (NO in step S79), the ADF controller 904 of the ADF 51 proceeds the process to step S80. In step S80, the ADF controller 904 of the ADF 51 temporarily stop the sheet feeding and reading operation, cause the display 905 to display the document thickness resetting notification screen 1000 as illustrated in FIG. 8 to prompt the user for confirmation, and cause the user to input whether to change the document thickness setting.

In step S81, the ADF controller 904 of the ADF 51 determines whether the document thickness setting is changed by the user. When the document thickness setting is not changed by the user (NO in step S81), the ADF controller 904 of the ADF 51 returns to step S72 to continue the first step to perform the reading operation on the subsequent original document. In contrast, when the document thickness setting is changed by the user (YES in step S81), the ADF controller 904 of the ADF 51 proceeds to step S82 to start the sheet feeding and reading operation with the conveyance control amount optimum for the document thickness setting after the change.

In FIGS. 18A and 18B, the flowchart from the first step to the second step has been described, but it is also considered that documents having different thicknesses are mixed after the process proceeds to the second step. Even after the document thickness setting is changed in the second step, the ADF controller 904 of the ADF 51 may return to the start of the flowchart illustrated in FIGS. 18A and 18B and repeatedly start the first step of estimating the matching degree for each sheet thickness of the original document using the trained model 200. In the present embodiment, the first step represents the sheet (document) feeding and reading operation that includes a process of estimating the matching degree. In the first step, the conveyance is performed with the conveyance control amount applicable to the classifications of all the original documents. The second step represents the sheet (document) feeding and reading operation that does not include the process of estimating the matching degree. In the second step, the conveyance is performed with the conveyance control amount applicable to the document thickness setting after the change.

Further, when it is determined that the sheet thickness setting is different in step S77 over multiple times (for example, three times or more) in the same job, it is determined that the original documents having different sheet thicknesses are mixed, and the ADF controller 904 of the ADF 51 may execute the control in which the matching degree of the sheet thickness is not estimated or determined.

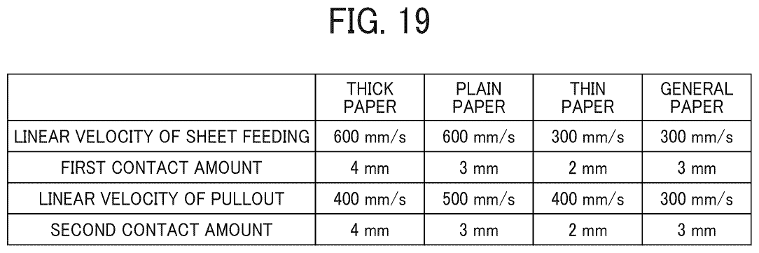

FIG. 19 is a diagram illustrating an example of optimum conveyance parameters for each sheet thickness.

The sheet feeding linear velocity of the conveyance parameter in FIG. 19 is the maximum linear velocity during conveyance from the start of separation and feeding of the original document to the time when the leading end of the original document reaches the pullout driven roller 87 in the configuration illustrated in FIG. 5.

The pullout linear velocity is the maximum linear velocity during conveyance to the time when the leading end of the original document reaches the scan entrance roller pairs 89 and 90 from the pullout driven roller 87. The first contact amount is a contact amount of an original document to the pullout driven roller 87. The second contact amount is a contact amount of an original document to the scan entrance roller pairs 89 and 90.

For each of the sheet thicknesses (thick paper, plain paper, and thin paper), an optimum parameter determined by a designer through, for example, simulation and sheet passing evaluation is set. Further, the sheet thickness “general-purpose” is set with a parameter applicable to all sheet thicknesses. The sheet thickness “general-purpose” is designed to have low productivity but to have a small skew amount and a small damage to the original document. For example, the conveyance parameter in the first step of FIG. 18A uses the parameter of the paper thickness “general purpose”.

The reason why the parameters of FIG. 19 are optimal for each sheet thickness is that, for example, the first contact amount and the second contact amount are increased compared to other sheet thicknesses because the heavy sheet has a large mass and requires a larger contact amount to correct the skew amount.

The sheet feeding liner velocity of the conveyance parameter is preferably high to maintain the productivity. However, since the linear velocity of a thin paper is relatively fast when contacting a roller and the leading end of the original document tends to bend more easily as the contact amount of the original document increases, the pullout linear velocity is slower than the linear velocities of the other sheet thicknesses and the first contact amount and the second contact amount are decreased.

In the present embodiment, the sheet thickness (thick paper, plain paper and thin paper) is described as to multiple classifications of original documents. However, the sheet kind (plain paper, coated paper, non-carbon paper) is also considered in addition to the sheet thickness. In the case of a special original document such as coated paper or non-carbon paper, the control such as lowering the linear velocity compared to plain paper is considered as optimal conveyance control. Further, checks and business cards used in the present embodiment are described as the examples.

In the present embodiment, size information of an original document set on the document tray of the ADF 51 is acquired from, for example, a user input or sensor information of the document tray, and the kind of original document (for example, sheet thickness) is estimated from the size information.

In the present embodiment, the kind of original document (for example, sheet thickness) is estimated by the trained model 2000 that has been subjected to machine learning based on the image data read by the ADF 51 as an input. Even when the kind of original document to be read that is actually placed on the document tray is different from the kind of original document that has been set in advance, the control can be switched (changed) to the conveyance control and reading control appropriate to the kind of the original document.

Each function of the embodiments described above can be implemented by one processing circuit or a plurality of processing circuits. The term “processing circuit or circuitry” in the present specification includes a programmed processor to execute each function by software, such as the CPU 241 implemented by an electronic circuit, and devices, such as an application specific integrated circuit (ASIC), a digital signal processor (DSP), a field programmable gate array (FPGA), and conventional circuit components arranged to perform the recited functions.

Aspects of the present disclosure are described based on the above-described embodiments, but the present disclosure are not limited to the elements of the above-described embodiments. The elements of the above-described embodiments can be modified without departing from the gist of the present disclosure, and can be appropriately determined according to the application form.

Aspects of the present disclosure are, for example, as follows.

### Aspect 1

A document processing apparatus includes a document tray, a document conveyor, a document information acquisition unit, a control amount determination unit, and an estimation unit. The document conveyor conveys the document from the document tray. The document information acquisition unit acquires information of the document. The control amount determination unit determines a conveyance control amount to convey the document, based on a classification of the document determined in advance. The estimation unit estimates a classification of the document based on the information of the document as an input. The control amount determination unit changes the conveyance control amount when a result of the classification of the document estimated by the estimation unit and the classification of the document determined in advance are different from each other.

According to Aspect 1, when the document thickness setting (e.g., a thick paper mode) set in advance and a document thickness setting estimated from, for example, size information are different, the user may make a setting error. For this reason, by changing the sheet thickness setting, even if the user makes a setting error, an image on the document can be read under control optimal for each sheet thickness.

### Aspect 2

In Aspect 2, the document processing apparatus according to Aspect 1 further includes an image reader to read an image on the document when the document is conveyed by the document conveyor. The estimation unit includes a trained model having the information of the document and image data acquired by the image reader as an input to output a matching degree of multiple classifications of the document. The control amount determination unit changes the conveyance control amount when the matching degree output by the trained model exceeds a threshold value.

According to Aspect 2, when the document thickness setting set in advance and the document thickness setting estimated by the trained model from the image data of the read document are different, the user may make a setting error. For this reason, by changing the sheet thickness setting, even if the user makes a setting error, the image on the document can be read under control optimal for each sheet thickness.

### Aspect 3

In Aspect 3, the document processing apparatus according to Aspect 2 further includes a notification unit and an input unit. The notification unit notifies a user of whether to change the conveyance control amount when the matching degree output by the trained model exceeds a threshold value. The input unit receives an instruction from the user of whether to change the conveyance control amount.

According to Aspect 3, since the estimation by the trained model is not absolutely correct, whether the estimated result is actually correct is confirmed by the user, and then the sheet thickness setting can be changed.

### Aspect 4

In Aspect 4, in the document processing apparatus according to any one of Aspects 1 to 3, the document information acquisition unit is a sensor to detect a size of the document, and the information of the document includes size information of the document.

According to Aspect 4, by adding the size of the document detected by the sensor to a training data, a matching degree can be estimated with higher accuracy.

### Aspect 5

In Aspect 5, in the document processing apparatus according to any one of Aspects 1 to 4, the document information acquisition unit includes a receiver to receive an instruction of the size of the document from the user. The information of the document includes information of the size of the document.

According to Aspect 5, by adding the size of the document input by the user to the training data, the matching degree can be estimated with higher accuracy.

### Aspect 6

In Aspect 6, in the document processing apparatus according to any one of Aspects 1 to 5, the conveyance control amount changed by the control amount determination unit is a conveyance speed of the document or a contact amount of the document to the document conveyor.

### Aspect 7

In Aspect 7, in the document processing apparatus according to Aspect 2, the conveyance control amount includes a general-purpose conveyance control amount that is the conveyance control amount applicable to a classification of all documents. The document conveyor has a first step of performing conveyance of the document with the general-purpose conveyance control amount, and a second step of performing conveyance of the document with the conveyance control amount changed by the control amount determination unit.

According to Aspect 7, the document is conveyed and read more carefully by, for example, reducing the conveyance speed until an image of the first document is read to identify the kind of the document. After an optimum mode is determined according to the result of the estimation, the subsequent operation is performed in the optimum mode. By so doing, the reading operation is performed while performing the conveyance and reading optimum to all the documents and minimizing a decrease in the productivity.

### Aspect 8

In Aspect 8, in the document processing apparatus according to Aspect 7, the document information acquisition unit includes a sensor to detect whether there is a document placed on the document tray. When the sensor detects no document to be subjected to the second step is on the document tray in the first step, estimation of the classification of the document is not performed by the estimation unit.

According to Aspect 8, if there is no subsequent document, it is meaningless to estimate the matching degree after the first step. Accordingly, useless operations are reduced, and the job can be quickly processed.

### Aspect 9

In Aspect 9, in the document processing apparatus according to Aspect 7, the matching degree of multiple classifications of the document by the trained model is output, and whether the matching degree output by the trained model exceeds the threshold value.

According to Aspect 9, even if the sheet is once determined as a thick paper, if a thin paper or any paper other than the thick paper is mixed, the mode can be switched to the thin paper mode after the previous determination as a thick paper.

### Aspect 10

In Aspect 10, the document processing apparatus according to Aspect 9, in the first step or the second step, when conveyance control amount is changed multiple times since the matching degree output by the trained model exceeds the threshold value, the matching degree by the trained model is not output or the conveyance control amount is not changed even if the matching degree exceeds the threshold value.

According to Aspect 10, when the conveyance control amount needs to be changed multiple times, the estimation by the trained model is not performed since it is highly likely that the sheet thickness and sheet kind are mixed.

### Aspect 11

In Aspect 11, in the document processing apparatus according to Aspect 3, there are multiple threshold values including a first threshold value and a second threshold value. When the matching degree exceeds the first threshold value and does not exceed the second threshold value, the notification unit notifies the user. When the matching degree exceeds the first threshold value and the second threshold value, the user is not notified but the control amount determination unit automatically changes the conveyance control amount.

According to Aspect 11, there are multiple threshold values, the user is notified when the matching degree is not so high, and the user is not notified but the operation is automatically performed when the matching degree is relatively high. By so doing, an unnecessary operation by the user can be omitted.

### Aspect 12

In Aspect 12, in the document processing apparatus according to Aspect 2 or 3, the threshold value is changeable by the user.

According to Aspect 12, the user can set the determination of the matching degree to be strict, normal, or loose.

### Aspect 13

In Aspect 13, in the document processing apparatus according to Aspect 7, the document conveyor continues the control with the general-purpose conveyance control amount until a matching degree of multiple classifications of the document by the trained model that outputs the matching degree of the multiple classifications of the document based on the image data acquired by the image reader as an input is output in the first step.

According to Aspect 13, there is a case where it takes some time to make the determination based on the matching degree, and there are a case where it is faster to wait and a case where it is faster to complete a job by continuing reading of the subsequent document in the first step without waiting and proceeding to the second step when a result is obtained.

### Aspect 14

In Aspect 14, in the document processing apparatus according to any one of Aspects 1 to 13, the classification of the document includes sheet thickness information or sheet kind information.

### Aspect 15

In Aspect 15, in the document processing apparatus according to any one of Aspects 1 to 13, the document processing apparatus is attached to an image forming apparatus.

According to Aspect 15, the image forming device 1 may include a central processing unit (CPU) that performs estimation by the trained model 2000, and a reduction in cost can be achieved.

### Aspect 16

A document processing system includes a document processing apparatus and an external device. The document processing apparatus includes a document tray, a document conveyor, a document information acquisition unit, and a control amount determination unit. The document conveyor conveys the document from the document tray. The document information acquisition unit acquires information of the document. The control amount determination unit determines a conveyance control amount to convey the document, based on a classification of the document determined in advance. The external device includes an estimation unit that estimates a classification of the document based on the information of the document received from the document processing apparatus as an input. The control amount determination unit changes the conveyance control amount when a result of the classification of the document estimated by the estimation unit and the classification of the document determined in advance are different from each other.

According to Aspect 16, even if a personal computer (PC) includes the CPU that performs estimation by the trained model 2000, a reduction in cost can be achieved. The CPU that performs inference using the trained model 2000 may be included in the cloud server 908 externally provided, and the trained model 2000 can be shared with another system to obtain an efficient learning effect.

### Aspect 17

In Aspect 17, a document processing apparatus includes a document tray, a document conveyor, and circuitry. The document tray is a tray on which a document is placed. The document conveyor conveys the document from the document tray. The circuitry is to acquire information of the document, determine a conveyance amount to convey the document, based on a first classification of the document previously set, estimate a second classification of the document based on the information of the document acquired, and change the conveyance amount when the first classification is different from the second classification.

### Aspect 18

In Aspect 18, the document processing apparatus according to Aspect 17 further includes an image reader to read an image on the document when the document is conveyed by the document conveyor. The circuitry is further to use a trained model to output a matching degree between the first classification and the second classification based on the information of the document and the image read by the image reader, and change the conveyance amount when the trained model outputs the matching degree exceeding a threshold value.

### Aspect 19

In Aspect 19, in the document processing apparatus according to Aspect 18, the circuitry is further to output a notification whether to change the conveyance amount when the trained model outputs the matching degree exceeding the threshold value.

### Aspect 20

In Aspect 20, in the document processing apparatus according to Aspect 19, multiple threshold values including the threshold value, multiple threshold values include a first threshold value, and a second threshold value larger than the first threshold value. The circuitry is further to output the notification when the trained model outputs the matching degree exceeding the first threshold value and not exceeding the second threshold value, and automatically change the conveyance amount without outputting the notification when the trained model outputs the matching degree exceeding both the first threshold value and the second threshold value.

### Aspect 21

In Aspect 21, in the document processing apparatus according to Aspect 18, the circuitry is further to determine the conveyance amount to a general-purpose conveyance amount applicable to all classifications of the document including the first classification and the second classification, perform a first step to convey the document with the general-purpose conveyance amount, and perform a second step to convey the document with the conveyance amount changed.

### Aspect 22

In Aspect 22, the document processing apparatus according to Aspect 21 further includes a sensor to detect the document on the document tray. The circuitry does not estimate a classification of the document when, in the first step, the sensor detects that there is no document conveyed by the second step on the document tray.

### Aspect 23

In Aspect 23, in the document processing apparatus according to Aspect 21, the circuitry is further, in the first step and the second step, to control the trained model to output the matching degree between the first classification and the second classification, and determine whether the trained model outputs the matching degree exceeding the threshold value.

### Aspect 24

In Aspect 24, in the document processing apparatus according to Aspect 23, the circuitry is further, in the first step and the second step, to hold the output of the matching degree of the first classification of the document and the second classification of the document by the trained model, or maintain the conveyance amount with the matching degree exceeding the threshold value, when the conveyance amount is changed multiple times after the matching degree output by the trained model exceeds the threshold value.

### Aspect 25

In Aspect 25, in the document processing apparatus according to Aspect 23, the document conveyor continues control of conveyance of the document with the general-purpose conveyance amount until a matching degree of multiple classifications of the document by the trained model that outputs a matching degree of multiple classifications of the document based on image data as an input is output in the first step.

### Aspect 26

In Aspect 26, in the document processing apparatus according to Aspect 18 or 19, the threshold value is manually changeable.

### Aspect 27

In Aspect 27, the document processing apparatus according to Aspect 17 further includes a sensor to detect a size of the document. The circuitry is further to cause the sensor to detect the size of the document. The information of the document includes information of the size of the document.

### Aspect 28

In Aspect 28, the document processing apparatus according to Aspect 17 further includes a receiver. The circuitry is further to cause the receiver to receive an input of a designation of a size of the document. The information of the document includes information of the size of the document.

### Aspect 29

In Aspect 29, in the document processing apparatus according to Aspect 17, the conveyance amount that is changed by the circuitry is a conveyance speed of the document or a contact amount of the document to the document conveyor.

### Aspect 30

In Aspect 30, in the document processing apparatus according to Aspect 17, each of the first classification and the second classification includes a thickness or a kind of the document.

### Aspect 31

In Aspect 31, in the document processing apparatus according to Aspect 17, the document processing apparatus is attached to an image forming apparatus.

### Aspect 32

In Aspect 32, a document processing system includes a document processing apparatus and an external device. The document processing apparatus includes a document tray, a document conveyor, and circuitry. The document tray is a tray on which a document is placed. The document conveyor conveys the document from the document tray. The circuitry is to acquire information of the document, and determine a conveyance amount to convey the document, based on a first classification of the document determined in advance. The external device includes circuitry configured to estimate a second classification of the document based on the information of the document as an input. The circuitry of the document processing apparatus is further to change the conveyance amount when the first classification of the document determined in advance and a result of the second classification of the document are different from each other.

### Aspect 33

In Aspect 33, a document processing apparatus includes a document tray, a document conveyor, and circuitry. The document tray is a tray on which a document is placed. The document conveyor conveys the document from the document tray. The circuitry is to acquire a size of the document, determine a conveyance amount to convey the document, based on a first thickness of the document previously set, estimate a second thickness of the document based on the size of the document acquired, and change the conveyance amount when the first thickness is different from the second thickness.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A document processing apparatus comprising:
a document tray on which a document is placed;
a document conveyor to convey the document from the document tray; and
circuitry configured to:
acquire information of the document;
determine a conveyance amount to convey the document, based on a first classification of the document previously set;
estimate a second classification of the document based on the information of the document acquired; and
change the conveyance amount when the first classification is different from the second classification.

2. The document processing apparatus according to claim 1, further comprising an image reader to read an image on the document when the document is conveyed by the document conveyor,
wherein the circuitry is further configured to:
use a trained model to output a matching degree between the first classification and the second classification based on the information of the document and the image read by the image reader; and
change the conveyance amount when the trained model outputs the matching degree exceeding a threshold value.

3. The document processing apparatus according to claim 2,
wherein the circuitry is further configured to output a notification whether to change the conveyance amount when the trained model outputs the matching degree exceeding the threshold value.

4. The document processing apparatus according to claim 3,
wherein multiple threshold values including the threshold value, multiple threshold values include:
a first threshold value; and
a second threshold value larger than the first threshold value, and the circuitry is further configured to:
output the notification when the trained model outputs the matching degree exceeding the first threshold value and not exceeding the second threshold value; and
automatically change the conveyance amount without outputting the notification when the trained model outputs the matching degree exceeding both the first threshold value and the second threshold value.

5. The document processing apparatus according to claim 2,
wherein the circuitry is further configured to:
determine the conveyance amount to a general-purpose conveyance amount applicable to all classifications of the document including the first classification and the second classification;
perform a first step to convey the document with the general-purpose conveyance amount; and
perform a second step to convey the document with the conveyance amount changed.

6. The document processing apparatus according to claim 5, further comprising a sensor to detect the document on the document tray,
wherein the circuitry does not estimate a classification of the document when, in the first step, the sensor detects that there is no document conveyed by the second step on the document tray.

7. The document processing apparatus according to claim 5,
wherein the circuitry is further configured, in the first step and the second step, to:
control the trained model to output the matching degree between the first classification and the second classification; and
determine whether the trained model outputs the matching degree exceeding the threshold value.

8. The document processing apparatus according to claim 7,
wherein the circuitry is further configured, in the first step and the second step, to:
hold the output of the matching degree of the first classification of the document and the second classification of the document by the trained model; or
maintain the conveyance amount with the matching degree exceeding the threshold value,
when the conveyance amount is changed multiple times after the matching degree output by the trained model exceeds the threshold value.

9. The document processing apparatus according to claim 5,
wherein the document conveyor continues control of conveyance of the document with the general-purpose conveyance amount until a matching degree of multiple classifications of the document by the trained model that outputs a matching degree of multiple classifications of the document based on image data as an input is output in the first step.

10. The document processing apparatus according to claim 2,
wherein the threshold value is manually changeable.

11. The document processing apparatus according to claim 1, further comprising a sensor to detect a size of the document,
wherein the circuitry is further configured to cause the sensor to detect the size of the document, and
the information of the document include information of the size of the document.

12. The document processing apparatus according to claim 1, further comprising a receiver,
wherein the circuitry is further configured to cause the receiver to receive an input of a designation of a size of the document, and
the information of the document include information of the size of the document.

13. The document processing apparatus according to claim 1,
wherein the conveyance amount that is changed by the circuitry is a conveyance speed of the document or a contact amount of the document to the document conveyor.

14. The document processing apparatus according to claim 1,
wherein each of the first classification and the second classification includes a thickness or a kind of the document.

15. The document processing apparatus according to claim 1,
wherein the document processing apparatus is attached to an image forming apparatus.

16. A document processing system comprising:
a document processing apparatus including:
a document tray on which a document is placed;
a document conveyor to convey the document from the document tray; and
circuitry configured to:
acquire information of the document; and
determine a conveyance amount to convey the document, based on a first classification of the document determined in advance; and
an external device including circuitry configured to estimate a second classification of the document based on the information of the document as an input,
wherein the circuitry of the document processing apparatus is further configured to change the conveyance amount when the first classification of the document determined in advance and a result of the second classification of the document are different from each other.

17. A document processing apparatus comprising:
a document tray on which a document is placed;
a document conveyor to convey the document from the document tray; and
circuitry configured to:
acquire a size of the document;
determine a conveyance amount to convey the document, based on a first thickness of the document previously set;
estimate a second thickness of the document based on the size of the document acquired; and
change the conveyance amount when the first thickness is different from the second thickness.
